(19) United States
(12) Patent Application Publication
(10) Pub. No.: US 2018/0249437 A1
(43) Pub. Date: Aug. 30, 2018

(54) ACCESS POINT (AP) TO ACCESS POINT (AP) RANGING FOR PASSIVE LOCATIONING

(71) Applicant: QUALCOMM Incorporated, San Diego, CA (US)

(72) Inventors: Erik David Lindskog, Cupertino, CA (US); Naveen Kumar Kakani, Irving, TX (US); Alireza Raissinia, Monte Sereno, CA (US)

(21) Appl. No.: 15/902,289

(22) Filed: Feb. 22, 2018

Related U.S. Application Data
(60) Provisional application No. 62/464,372, filed on Feb. 27, 2017.

(51) Int. Cl. H04W 64/00; H04W 24/10

(52) U.S. Cl. CPC H04W 64/00; H04W 84/12; H04W 24/10

(57) ABSTRACT

This disclosure provides systems, methods and apparatus, including computer programs encoded on computer storage media, for performing ranging operations. In one aspect, an apparatus negotiates a passive ranging schedule between an initiator device and a number of responder devices. The passive ranging schedule indicates a time prior to a selected target beacon transmission time (TBTT) at which the ranging operation is to commence. The apparatus announces the passive ranging schedule to at least one or more passive listening devices, commences the ranging operation at the indicated time by exchanging a number of frames between the initiator device and the number of responder devices, and completes the exchange of frames prior to the selected TBTT.

### CROSS-REFERENCE TO RELATED APPLICATION

This Patent Application claims priority to U.S. Provisional Patent Application No. 62/464,372 entitled “ACCESS POINT TO ACCESS POINT RANGING FOR PASSIVE LOCATIONING” filed on Feb. 27, 2017, assigned to the assignee hereof. The disclosure of the prior Application is considered part of and is incorporated by reference in this Patent Application.

### TECHNICAL FIELD

This disclosure relates generally to wireless networks, and specifically to ranging operations for passive positioning.

### DESCRIPTION OF THE RELATED TECHNOLOGY

The recent proliferation of Wi-Fi® access points in wireless local area networks (WLANs) has made it possible for positioning systems to use these access points for position determination, especially in areas where there is a large concentration of active Wi-Fi access points (such as urban cores, shopping centers, office buildings, sporting venues, and so on). For example, a wireless device such as a cell phone or tablet computer may use the round trip time (RTT) of signals exchanged with an access point (AP) to determine the distance between the wireless device and the AP. Once the distances between the wireless device and three APs having known locations are determined, the location of the wireless device may be determined using trilateration techniques.

Because ranging operations are becoming more important for position determination, it is desirable to increase the speed with which ranging operations may be performed while also increasing ranging accuracy. In addition, it is desirable to perform ranging operations with multiple wireless devices at the same time, and to allow wireless devices to passively participate in ranging operations.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless network to perform ranging operations between an initiator device and a number of responder devices. The initiator device can negotiate, with the number of responder devices, a passive ranging schedule indicating a time prior to a selected target beacon transmission time (TBTT) at which the ranging operation is to commence. The passive ranging schedule can include a participant field, a parameters field, a synchronization field, or any combination thereof. In some implementations, the participant field can include at least one of an identity of each device participating in the ranging operation, an indication of whether each of the identified participant devices is an access point or a client device, and an indication of whether each of the identified participant devices is to operate as the initiator device or as one of the responder devices. In some implementations, the parameters field can include at least one of a type of frames to be exchanged during the ranging operation, a number of antennas to be used by the responder devices during the ranging operation, a frequency bandwidth to be used for transmitting the frames, a wireless channel to be used for the ranging operation, a capability to capture timestamps of the frames, and a capability to estimate angle information of the frames. In some implementations, the synchronization field can include mappings between a clock domain of the initiator device and clock domains of each of the responder devices, where the mappings include at least clock offset values between the clock domain of the initiator device and the clock domains of the responder devices.

The initiator device can announce the passive ranging schedule to the number of responder devices and to a number of passive listening devices. The initiator device can announce the passive ranging schedule in beacon frames, in probe responses, or both. In some implementations, the initiator device can periodically embed the passive ranging schedule within beacon frames (such as within every N^{th} beacon frame, where N is an integer greater than one). In some other implementations, the initiator device can embed the passive ranging schedule within all beacon frames.

The initiator device can commence the ranging operation at the indicated time by exchanging a number of frames with the number of responder devices. In some implementations, the frames can be exchanged according to a fine timing measurement (FTM) protocol. In addition, or in the alternative, the exchanged frames can include a number of multi-user null data packets (MU-NDPs). In some implementations, the MU-NDPs can include a number of sounding sequences from which angle information and multiple round trip time (RTT) values can be obtained.

The initiator device can facilitate a passive positioning operation for each of the passive listening devices using the exchanged frames, and can complete the exchange of frames prior to the selected TBTT. In some implementations, the passive listening device can determine a differential distance between itself and each of a pair of the initiator device and one of the responder devices based on timing information provided by the initiator device, timing information provided by the responder devices, and time of arrival (TOA) values of the exchanged frames determined by the passive listening device.

Another innovative aspect of the subject matter described in this disclosure can be implemented as a method for performing a ranging operation. The method can include negotiating a passive ranging schedule between an initiator device and a number of responder devices, and announcing the passive ranging schedule to the number of responder devices and to a number of passive listening devices. The passive ranging schedule can indicate a time prior to a selected target beacon transmission time (TBTT) at which the ranging operation is to commence. The method also can include commencing the ranging operation at the indicated time by exchanging a number of frames between the initiator device and the number of responder devices, facilitating a passive positioning operation for each of the passive listening devices using the exchanged frames, and completing the exchange of frames prior to the selected TBTT.

Another innovative aspect of the subject matter described in this disclosure can be implemented in a non-transitory computer-readable storage medium. The non-transitory computer-readable storage medium can store instructions that, when executed by one or more processors of an apparatus, cause the apparatus to perform a number of operations. The number of operations can include negotiating a passive ranging schedule between an initiator device and a number of responder devices, and announcing the passive ranging schedule to the number of responder devices and to a number of passive listening devices. The passive ranging schedule can indicate a time prior to a selected target beacon transmission time (TBTT) at which the ranging operation is to commence. The number of operations also can include commencing the ranging operation at the indicated time by exchanging a number of frames between the initiator device and the number of responder devices, facilitating a passive positioning operation for each of the passive listening devices using the exchanged frames, and completing the exchange of frames prior to the selected TBTT.

Another innovative aspect of the subject matter described in this disclosure can be implemented in an apparatus. The apparatus can include means for negotiating a passive ranging schedule between an initiator device and a number of responder devices, and can include means for announcing the passive ranging schedule to the number of responder devices and to a number of passive listening devices. The passive ranging schedule can indicate a time prior to a selected target beacon transmission time (TBTT) at which the ranging operation is to commence. The apparatus also can include means for commencing the ranging operation at the indicated time by exchanging a number of frames between the initiator device and the number of responder devices, means for facilitating a passive positioning operation for each of the passive listening devices using the exchanged frames, and means for completing the exchange of frames prior to the selected TBTT.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of an example wireless system.

FIG. 2 shows a block diagram of an example access point.

FIG. 3 shows a block diagram of an example wireless station.

FIG. 4 shows a signal diagram of an example ranging operation.

FIG. 5A shows a signal diagram of an example ranging operation.

FIG. 5B shows a timing diagram of the example ranging operation of FIG. 5A.

FIG. 5C shows a signal diagram of an example passive positioning operation.

FIG. 5D shows a timing diagram of a staggered uplink data transmission for the example ranging operation of FIG. 5A.

FIG. 5E shows a timing diagram of a symbol-interleaved uplink data transmission for the example ranging operation of FIG. 5A.

FIG. 6A shows a signal diagram of another example ranging operation.

FIG. 6B shows a timing diagram of the example ranging operation of FIG. 6A.

FIG. 6C shows a signal diagram of another example passive positioning operation.

FIG. 7A shows a signal diagram of another example ranging operation.

FIG. 7B shows a timing diagram of the example ranging operation of FIG. 7A.

FIG. 7C shows a signal diagram of another example passive positioning operation.

FIG. 8A shows a signal diagram of another example ranging operation.

FIG. 8B shows a timing diagram of the example ranging operation of FIG. 8A.

FIG. 8C shows a signal diagram of another example passive positioning operation.

FIG. 9A shows a signal diagram of another example ranging operation.

FIG. 9B shows a timing diagram of the example ranging operation of FIG. 9A.

FIG. 9C shows a signal diagram of another example passive positioning operation.

FIG. 10A shows an illustrative flow chart depicting an example ranging operation.

FIG. 10B shows an illustrative flow chart depicting an example frame exchange.

FIG. 10C shows an illustrative flow chart depicting another example frame exchange.

FIG. 10D shows an illustrative flow chart depicting another example frame exchange.

FIG. 11 shows an example table of sounding sequences.

FIG. 12A shows an example management frame.

FIG. 12B shows an example high efficiency (HE) packet.

FIG. 13 shows an example trigger frame.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 802.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may be used for passive locationing operations during which a passive listening device may determine its location by listening to frames exchanged between a number of active ranging devices (such as an initiator device and a number of responder devices). In some implementations, the initiator device may negotiate a passive ranging schedule with one or more responder devices. The passive ranging schedule may identify which wireless devices are to participate in ranging operations, may indicate a channel (or channels) upon which the ranging operations are to be performed, may indicate a frequency bandwidth to be used for the ranging operations, and may indicate times and durations of the ranging operations. In some implementations, frame exchanges associated with a ranging operation may be scheduled to begin a time period prior to a selected target beacon transmission time (TBTT), for example, so that the frame exchanges are completed prior to the transmission of a next beacon frame. A passive listening device may listen to the frame exchanges between the initiator device and the responder devices, and may capture timestamps of the received frames. The passive listening device also may receive timing information associated with the exchanged frames from the initiator device, from one or more of the responder devices, or a combination thereof. The passive listening device may use the captured timestamps and the received timing information to passively determine its location based on differential distances between the passive listening device and pairs of the initiator device and ones of the responder devices.

Particular implementations of the subject matter described in this disclosure can be implemented to realize one or more of the following potential advantages. By completing frame exchanges prior to the transmission of a next beacon frame, frame exchanges associated with ranging operations disclosed herein may not interfere with beacon frame transmissions. Additionally, by completing frame exchanges prior to a given TBTT, timing information of the exchanged frames may be included in the next beacon frame (which may alleviate the need to transmit a separate frame containing the timing information). In some implementations, an initiator device may be given final authority over one or more parameters of the ranging operation, for example, so that an access point operating as the initiator device may perform the ranging operations on its own channel Another potential advantage is that the methods and apparatuses disclosed herein may obviate the need for encryption of enhanced FTM frames, and also may obviate the need for authentication, for example, because an attacker may not know the identity of the wireless devices, and therefore may not be able to a mount a direct attack on the wireless devices participating in the ranging operations. In addition, the methods and apparatuses disclosed herein may allow passive listening devices to determine their locations without relying upon clock synchronizations between the initiator device and the responder devices. Another potential advantage is that the methods and apparatuses disclosed herein may allow a passive listening device to determine a differential distance between itself and each of a pair of the initiator device and one of the responder devices based on timing information provided by the initiator device, timing information provided by the pair of responder devices, and TOA values determined by the passive listening device. In this manner, the differential distance determined by the passive listening device may be independent of the time of flight of signals exchanged between each of the initiator device and the responder devices, and may therefore be insensitive to line-of-sight (LOS) signal obstructions between the initiator device and the responder devices.

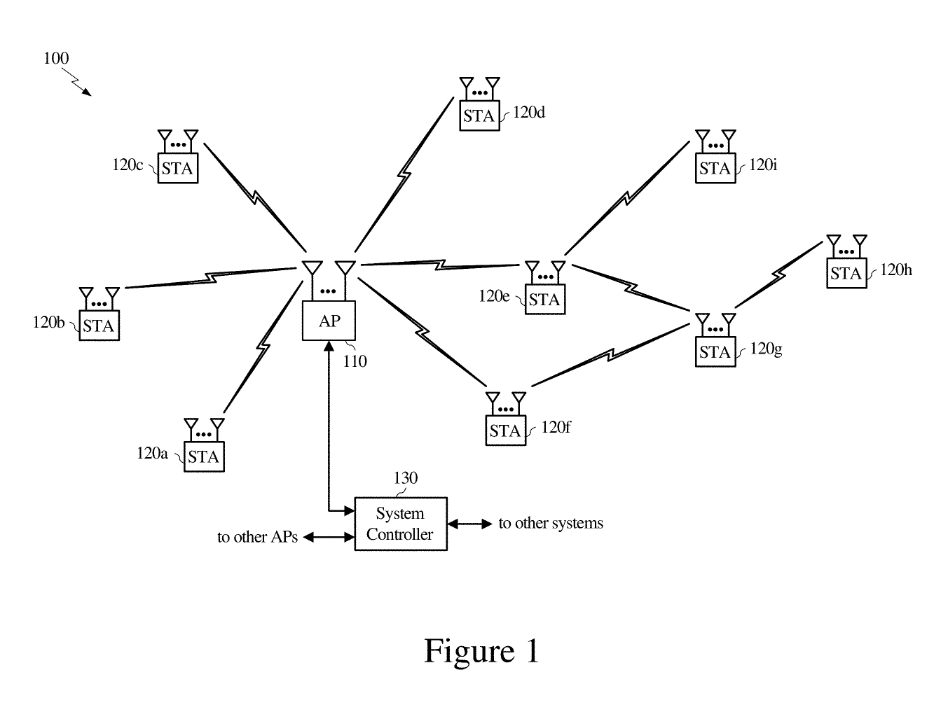

FIG. 1 shows a block diagram of an example wireless system 100. The wireless system 100 is shown to include a wireless access point (AP) 110 and a number of wireless stations (STAs) 120a-120i. For simplicity, only one AP 110 is shown in FIG. 1. The AP 110 may form a wireless local area network (WLAN) that allows the AP 110, the STAs 120a-120i, and other wireless devices (not shown for simplicity) to communicate with each other over a wireless medium. The wireless medium, which may be divided into a number of channels or into a number of resource units (RUs), may facilitate wireless communications between the AP 110, the STAs 120a-120i, and other wireless devices connected to the WLAN. In some implementations, the STAs 120a-120i can communicate with each other using peer-to-peer communications (such as without the presence or involvement of the AP 110). The AP 110 may be assigned a unique MAC address that is programmed therein by, for example, the manufacturer of the access point. Similarly, each of the STAs 120a-120i also may be assigned a unique MAC address.

In some implementations, the wireless system 100 may correspond to a multiple-input multiple-output (MIMO) wireless network, and may support single-user MIMO (SU-MIMO) and multi-user (MU-MIMO) communications. In some implementations, the wireless system 100 may support orthogonal frequency-division multiple access (OFDMA) communications. Further, although the WLAN is depicted in FIG. 1 as an infrastructure Basic Service Set (BSS), in some other implementations, WLAN may be an Independent Basic Service Set (IBSS), an Extended Service Set (ESS), an ad-hoc network, or a peer-to-peer (P2P) network (such as operating according to the Wi-Fi Direct protocols).

The STAs 120a-120i may be any suitable Wi-Fi enabled wireless devices including, for example, cell phones, personal digital assistants (PDAs), tablet devices, laptop computers, or the like. The STAs 120a-120i also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The AP 110 may be any suitable device that allows one or more wireless devices (such as the STAs 120a-120i) to connect to another network (such as a local area network (LAN), wide area network (WAN), metropolitan area network (MAN), or the Internet). In some implementations, a system controller 130 may facilitate communications between the AP 110 and other networks or systems, and also may facilitate communications between the AP 110 and one or more other APs (not shown for simplicity) that may be associated with other wireless networks. In addition, or in the alternative, the AP 110 may exchange signals and information with one or more other APs using wireless communications.

The AP 110 may periodically broadcast beacon frames to enable the STAs 120a-120i and other wireless devices within wireless range of the AP 110 to establish and maintain a communication link with the AP 110. The bacon frames, which may indicate downlink (DL) data transmissions to the STAs 120a-120i and solicit or schedule uplink (UL) data transmissions from the STAs 120a-120i, are typically broadcast according to a target beacon transmission time (TBTT) schedule. The broadcasted beacon frames may include the timing synchronization function (TSF) value of the AP 110. The STAs 120a-120i may synchronize their own local TSF values with the broadcasted TSF value, for example, so that all the STAs 120a-120i are synchronized with each other and the AP 110. In some implementations, one or more of the beacon frames may include or announce a passive ranging schedule indicating times and channels upon which the AP 110 is to either initiate or respond to ranging operations. One or more wireless devices (such as the STAs 120a-120i) may listen for and receive frames exchanged during the ranging operations to passively determine their location.

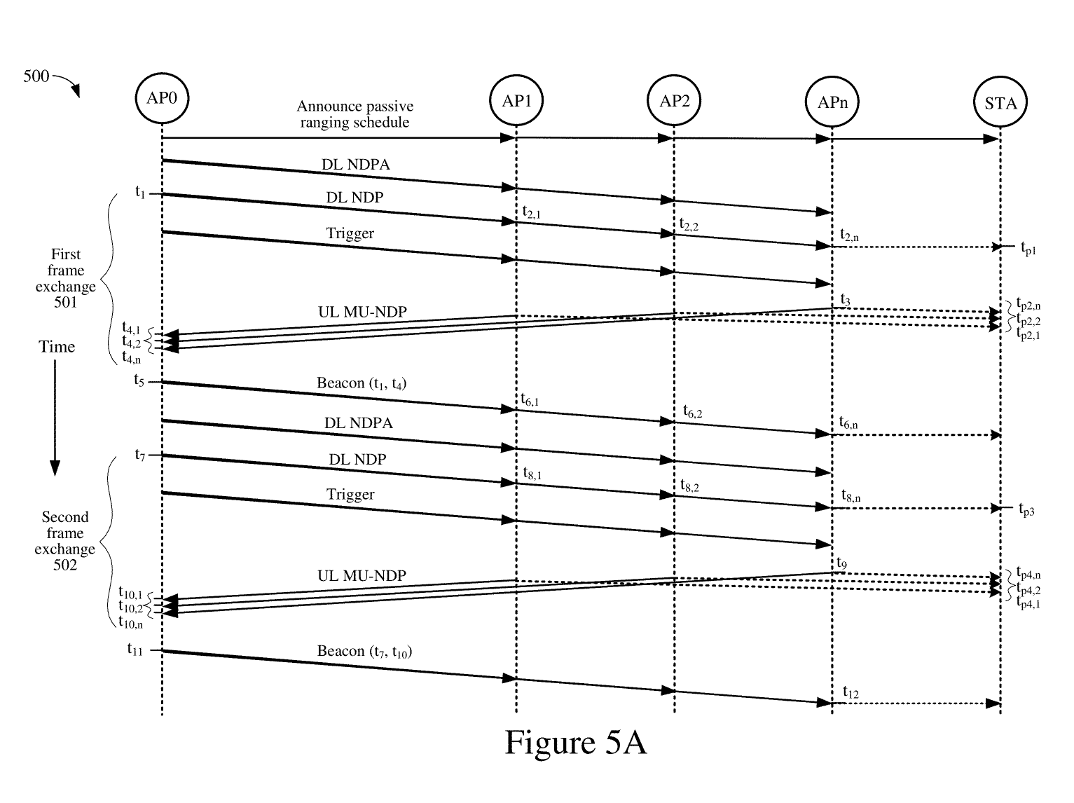

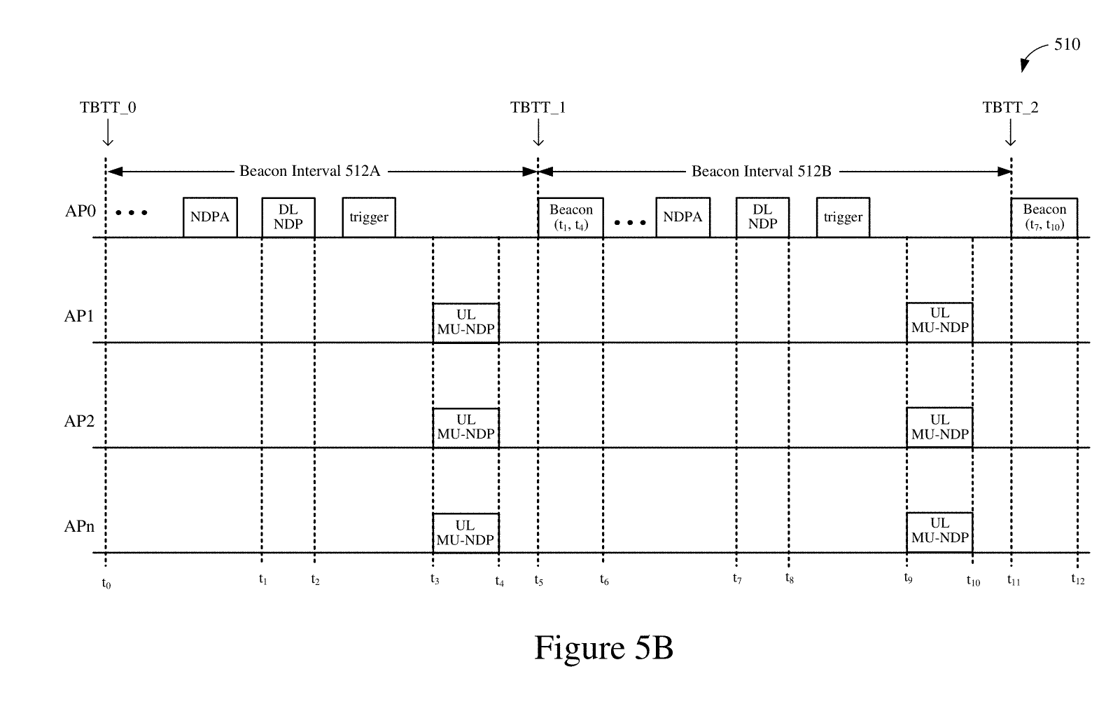

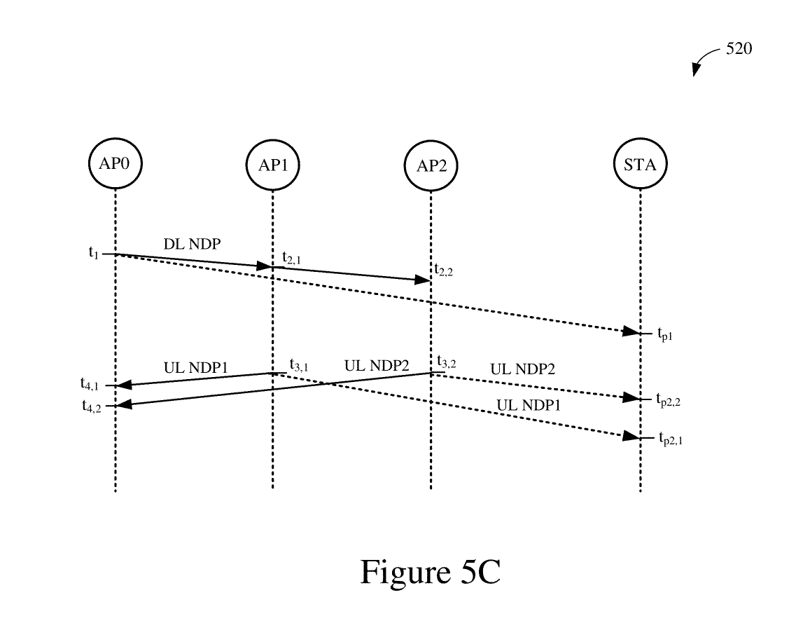

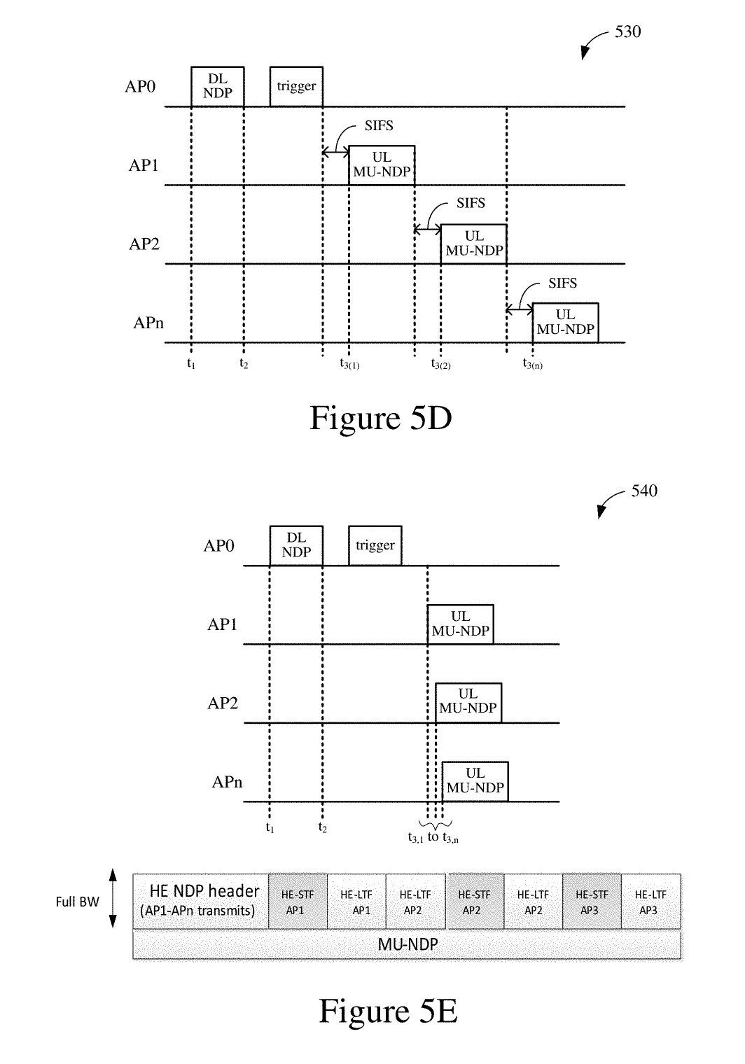

In some implementations, each of the stations STAs 120a-120i and the AP 110 may include one or more transceivers, one or more processing resources (such as processors or ASICs), one or more memory resources, and a power source (such as a battery for the STAs 120a-120i). The one or more transceivers may include Wi-Fi transceivers, Bluetooth transceivers, cellular transceivers, or other suitable radio frequency (RF) transceivers (not shown for simplicity) to transmit and receive wireless communication signals. In some implementations, each transceiver may communicate with other wireless devices in distinct frequency bands or using distinct communication protocols. The memory resources may include a non-transitory computer-readable medium (such as one or more nonvolatile memory elements, such as EPROM, EEPROM, Flash memory, a hard drive, etc.) that stores instructions for performing one or more operations described below with respect to FIGS. 5A-5E, 6A-6C, 7A-7C, 8A-8C, 9A-9C, and 10A-10D.

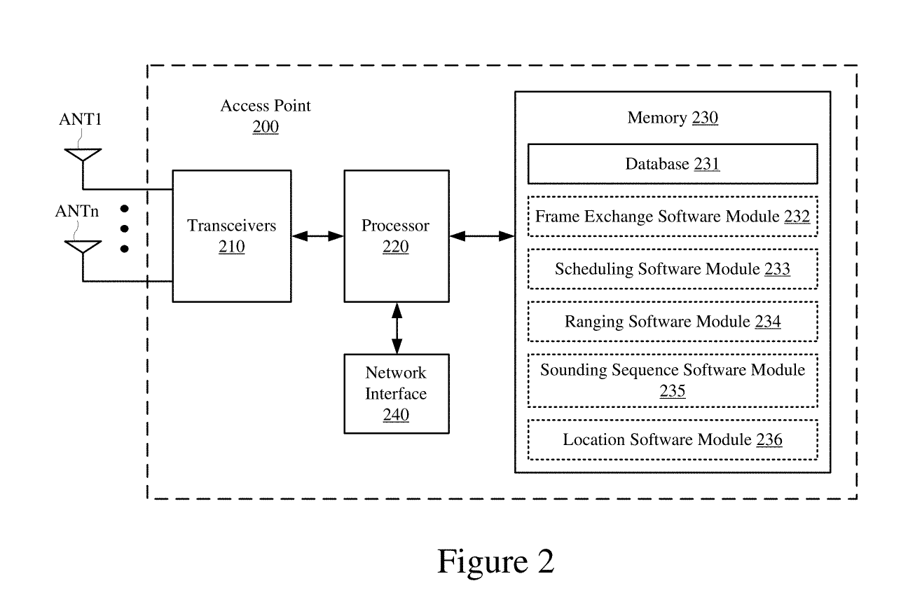

FIG. 2 shows an example access point (AP) 200. The AP 200 may be one implementation of the AP 110 of FIG. 1. The AP 200 may include one or more transceivers 210, a processor 220, a memory 230, a network interface 240, and a number of antennas ANT1-ANTn. The transceivers 210 may be coupled to the antennas ANT1-ANTn, either directly or through an antenna selection circuit (not shown for simplicity). The transceivers 210 may be used to transmit signals to and receive signals from other wireless devices including, for example, one or more of the STAs 120a-120i of FIG. 1 and other APs. Although not shown in FIG. 2 for simplicity, the transceivers 210 may include any number of transmit chains to process and transmit signals to other wireless devices via the antennas ANT1-ANTn, and may include any number of receive chains to process signals received from the antennas ANT1-ANTn. Thus, the AP 200 may be configured for MIMO communications and OFDMA communications. The MIMO communications may include SU-MIMO communications and MU-MIMO communications. In some implementations, the wireless device 200 may use multiple antennas ANT1-ANTn to provide antenna diversity. Antenna diversity may include polarization diversity, pattern diversity, and spatial diversity.

The network interface 240, which is coupled to the processor 220, may be used to communicate with the system controller 130 of FIG. 1. The network interface 240 also may allow the AP 200 to communicate, either directly or via one or more intervening networks, with other wireless systems, with other APs, with one or more back-haul networks, and so on.

The memory 230 may include a database 231 that may store location data, configuration information, data rates, MAC addresses, timing information, modulation and coding schemes, ranging capabilities, and other suitable information about (or pertaining to) a number of other wireless devices. The database 231 also may store profile information for a number of other wireless devices. The profile information for a given wireless device may include, for example, the wireless device's service set identification (SSID), BSSID, operating channels, TSF values, beacon intervals, ranging schedules, channel state information (CSI), received signal strength indicator (RSSI) values, goodput values, connection history with the AP 200, and previous ranging operations with the AP 200.

The memory 230 also may include a non-transitory computer-readable storage medium (such as one or more nonvolatile memory elements, such as EPROM, EEPROM, Flash memory, a hard drive, and so on) that may store the following software modules:
a frame exchange software module 232 to create and exchange ranging frames (such as FTM frames, NDPs, measurement feedback frames, response frames, and trigger frames) and other frames (such as data frames, control frames, and management frames) between the AP 200 and other wireless devices, for example, as described with respect to FIGS. 5A-5E, 6A-6C, 7A-7C, 8A-8C, 9A-9C, and 10A-10D;
a scheduling software module 233 to negotiate, establish, and announce passive ranging schedules to a number of other wireless devices, for example, as described with respect to FIGS. 5A-5E, 6A-6C, 7A-7C, 8A-8C, 9A-9C, and 10A-10D;
a ranging software module 234 to negotiate and perform ranging operations with other wireless devices, for example, as described with respect to FIGS. 5A-5E, 6A-6C, 7A-7C, 8A-8C, 9A-9C, and 10A-10D;
a sounding sequence software module 235 to create sounding sequences for transmission to other wireless devices, and to decode sounding sequences received from other wireless devices (such as to obtain RTT values, AoA information, and AoD information), for example, as described with respect to FIGS. 5A-5E, 6A-6C, 7A-7C, 8A-8C, 9A-9C, and 10A-10D; and
a location software module 236 to determine the location of one or more other wireless devices and to share location information of the AP 200 with other wireless devices, as described with respect to FIGS. 5A-5E, 6A-6C, 7A-7C, 8A-8C, 9A-9C, and 10A-10D.
   Each software module includes instructions that, when executed by the processor 220, may cause the AP 200 to perform the corresponding functions. The non-transitory computer-readable medium of the memory 230 thus includes instructions for performing all or a portion of the operations described below with respect to FIGS. 5A-5E, 6A-6C, 7A-7C, 8A-8C, 9A-9C, and 10A-10D.

The processor 220 may be any one or more suitable processors capable of executing scripts or instructions of one or more software programs stored in the AP 200 (such as within the memory 230). The processor 220 may execute the frame exchange software module 232 to create and exchange ranging frames (such as FTM frames, NDPs, measurement feedback frames, response frames, and trigger frames) and other frames (such as data frames, control frames, and management frames) between the AP 200 and other wireless devices. The processor 220 may execute the scheduling software module 233 to negotiate, establish, and announce passive ranging schedules to a number of other wireless devices.

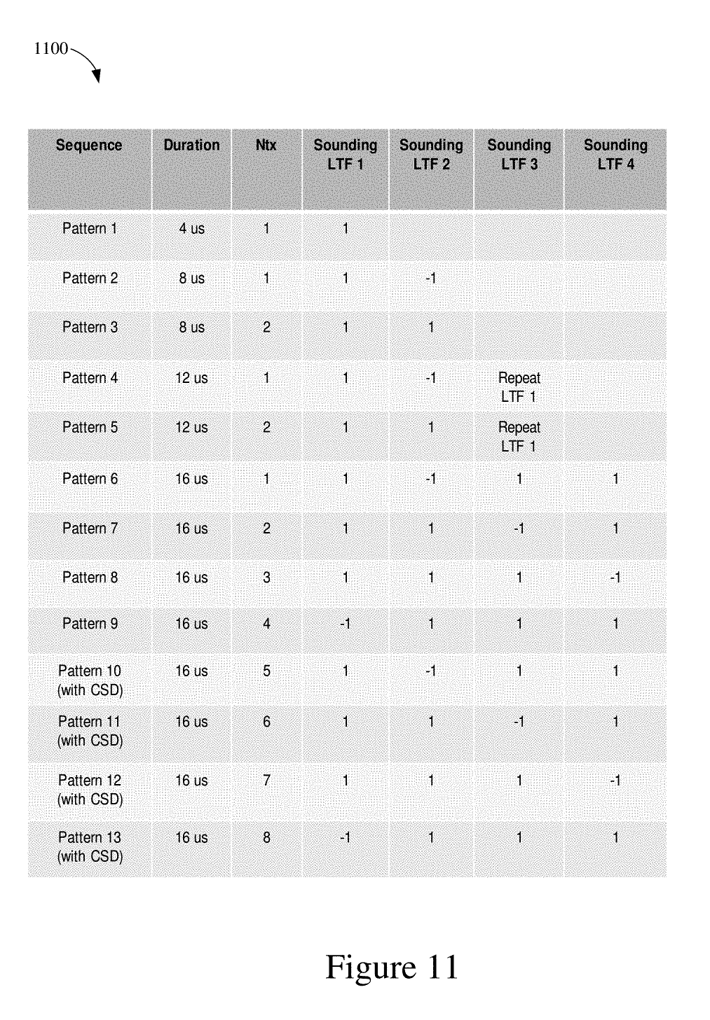

The processor 220 may execute the ranging software module 234 to negotiate and perform ranging operations with other wireless devices. In some implementations, the processor 220 may execute the ranging software module 234 to capture or record timestamps of signals received by the AP 200 (such as TOA information) and timestamps of signals transmitted from the AP 200 (such as TOD information), and to estimate angle information of frames exchanged with other wireless devices (such as AoA information and AoD information). The processor 220 may execute the sounding sequence software module 235 to create sounding sequences for transmission to other wireless devices, and to decode sounding sequences received from other wireless devices. In some implementations, the sounding sequences created by execution of the sounding sequence software module 235 may be based on a P-matrix (such as the P-matrix 1100 described herein with respect to FIG. 11).

The processor 220 may execute the location software module 236 to determine the location of one or more other wireless devices and to share location information of the AP 200 and possibly location of other APs in the vicinity with other wireless devices. In some implementations, location information determined by execution of the location software module 236 may be based on information provided by the ranging software module 234 and the sounding sequence software module 235.

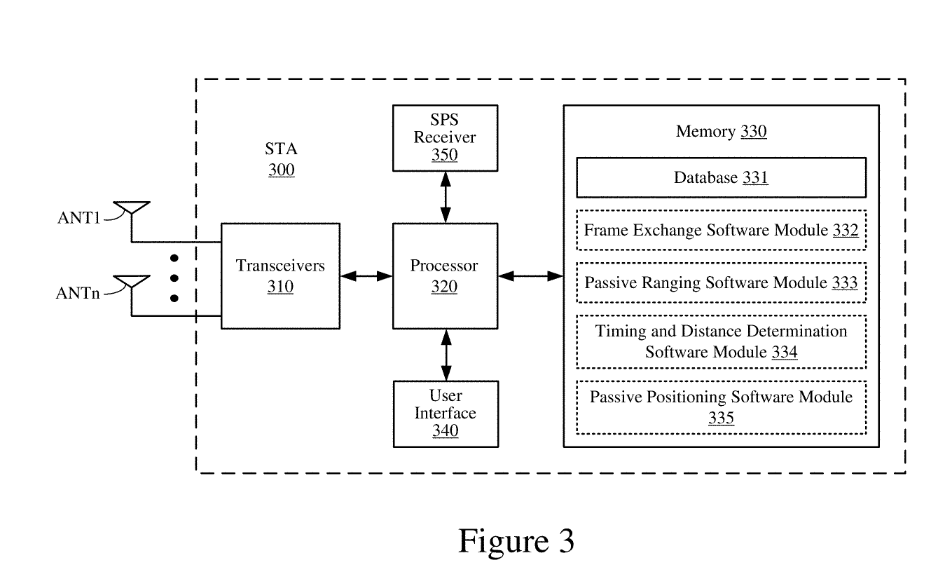

FIG. 3 shows an example wireless station (STA) 300. The STA 300 may be one implementation of at least one of the STAs 120a-120i of FIG. 1. The STA 300 may include one or more transceivers 310, a processor 320, a memory 330, a user interface 340, and a number of antennas ANT1-ANTn. The transceivers 310 may be coupled to antennas ANT1-ANTn, either directly or through an antenna selection circuit (not shown for simplicity). The transceivers 310 may be used to transmit signals to and receive signals from other wireless devices including, for example, a number of APs and a number of other STAs. Although not shown in FIG. 3 for simplicity, the transceivers 310 may include any number of transmit chains to process and transmit signals to other wireless devices via antennas ANT1-ANTn, and may include any number of receive chains to process signals received from antennas ANT1-ANTn. Thus, the STA 300 may be configured for MIMO communications and OFDMA communications. The MIMO communications may include SU-MIMO communications and MU-MIMO communications. In some implementations, the STA 300 may use multiple antennas ANT1-ANTn to provide antenna diversity. Antenna diversity may include polarization diversity, pattern diversity, and spatial diversity.

The user interface 340, which is coupled to the processor 320, may be or represent a number of suitable user input devices such as, for example, a speaker, a microphone, a display device, a keyboard, a touch screen, and so on. In some implementations, the user interface 340 may allow a user to control a number of operations of the STA 300, to interact with one or more applications executable by the STA 300, and other suitable functions.

In some implementations, the STA 300 may include a satellite positioning system (SPS) receiver 350. The SPS receiver 350, which is coupled to the processor 320, may be used to acquire and receive signals transmitted from one or more satellites or satellite systems via an antenna (not shown for simplicity). Signals received by the SPS receiver 350 may be used to determine (or at least assist with the determination of) a location of the STA 300.

The memory 330 may include a database 331 that may store location data, configuration information, data rates, MAC addresses, timing information, modulation and coding schemes, ranging capabilities, and other suitable information about (or pertaining to) a number of other wireless devices. The database 331 also may store profile information for a number of other wireless devices. The profile information for a given wireless device may include, for example, the wireless device's SSID, BSSID or MAC Address, operating channels, TSF values, beacon intervals, ranging schedules, CSI, RSSI values, goodput values, and previous ranging operations with the STA 300.

The memory 330 also may include a non-transitory computer-readable storage medium (such as one or more nonvolatile memory elements, such as EPROM, EEPROM, Flash memory, a hard drive, and so on) that may store the following software modules:
a frame exchange software module 332 to create and exchange frames (such as data frames, control frames, management frames, and action frames) between the STA 300 and other wireless devices, for example, as described with respect to FIGS. 5A-5E, 6A-6C, 7A-7C, 8A-8C, 9A-9C, and 10A-10D;
a passive ranging software module 333 to obtain or determine passive ranging schedules of other wireless devices, to exchange ranging capabilities with other wireless devices, and to listen for frames exchanged between other wireless devices during ranging operations, for example, as described with respect to FIGS. 5A-5E, 6A-6C, 7A-7C, 8A-8C, 9A-9C, and 10A-10D;
a timing and distance determination software module 334 to capture timestamps or estimate time of arrival (TOA) information of frames exchanged during ranging operations, to determine time difference of arrival (TDOA) values based on the exchanged frames, and to determine differential distances between the STA 300 and the other wireless devices, for example, as described with respect to FIGS. 5A-5E, 6A-6C, 7A-7C, 8A-8C, 9A-9C, and 10A-10D; and
a passive positioning software module 335 to determine the location of the STA 300 based on TDOA values, TOA values, differential distances, and location information of the other wireless devices, for example, as described with respect to FIGS. 5A-5E, 6A-6C, 7A-7C, 8A-8C, 9A-9C, and 10A-10D.
   Each software module includes instructions that, when executed by the processor 320, may cause the STA 300 to perform the corresponding functions. The non-transitory computer-readable medium of the memory 330 thus includes instructions for performing all or a portion of the operations described below with respect to FIGS. 5A-5E, 6A-6C, 7A-7C, 8A-8C, 9A-9C, and 10A-10D.

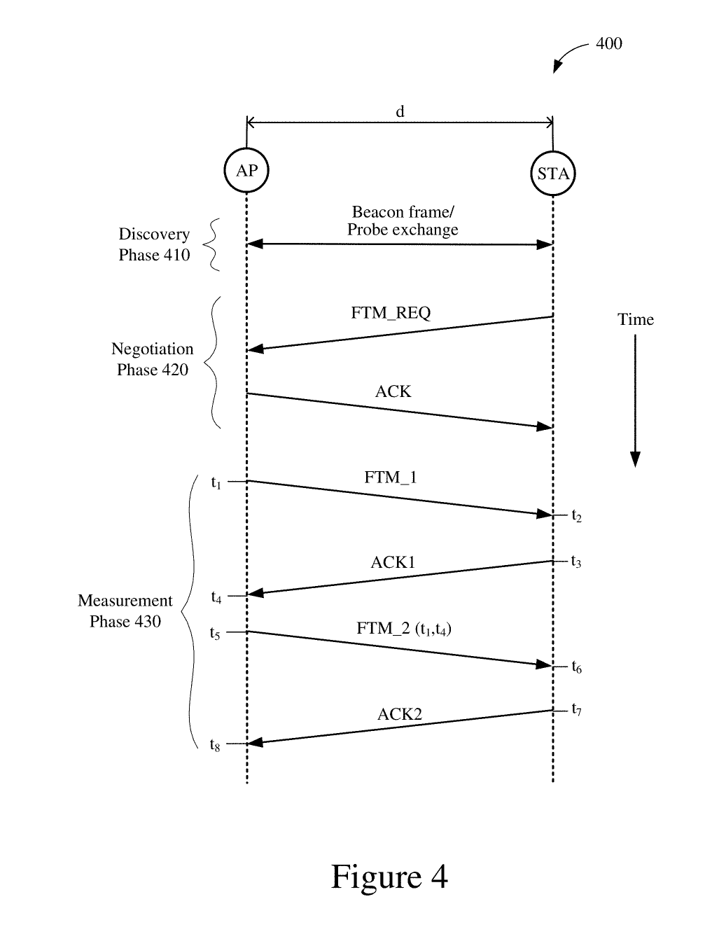

The processor 320 may be any one or more suitable processors capable of executing scripts or instructions of one or more software programs stored in the STA 300 (such as within the memory 330). The processor 320 may execute the frame exchange software module 332 to create and exchange frames (such as data frames, control frames, management frames, and action frames) between the STA 300 and other wireless devices. The processor 320 may execute the passive ranging software module 333 to obtain or determine passive ranging schedules (and the location) of other wireless devices, to exchange ranging capabilities with other wireless devices, and to listen for frames exchanged between other wireless devices during ranging operations. The processor 320 may execute the timing and distance determination software module 334 to capture timestamps or estimate time of arrival (TOA) information of frames exchanged during ranging operations, to determine time difference of arrival (TDOA) values based on the exchanged frames, and to determine differential distances between the STA 300 and the other wireless devices. The processor 320 may execute the passive positioning software module 335 to determine the location of the STA 300 based on TDOA values, TOA values, differential distances, received ToA and TOD values (determine range, example as shown in FIG. 4), when performing ranging operation directly with a wireless device, and location information of the other wireless devices.

FIG. 4 shows a signal diagram of an example ranging operation 400. The example ranging operation 400 is performed between a wireless station (STA) and an access point (AP) using Fine Timing Measurement (FTM) frames in accordance with the IEEE 802.11REVmc standards. For the example of FIG. 4, the STA requests the ranging operation; thus, the STA is the initiator device (or alternatively the requestor device) and the AP is the responder device. It is to be understood that any suitable wireless device can be the initiator device, and that any suitable wireless device can be the responder device.

The ranging operation 400 may include a discovery phase 410, a negotiation phase 420, and a measurement phase 430. During the discovery phase 410, the STA may discover other wireless devices, within range of the STA, that support ranging operations. In some implementations, the STA may discover the AP in an active manner, for example, by transmitting a probe request to the AP. The AP may respond by transmitting a probe response that indicates whether the AP supports FTM ranging operations. In some other implementations, the STA may discover the AP in a passive manner, for example, by receiving a beacon frame from the AP. The beacon frame may indicate whether the AP supports FTM ranging operations. In some other implementations, the STA may discover the AP using out-of-band signaling such as, for example, Bluetooth Low Energy (BLE) messages.

During the negotiation phase 420, the STA and the AP may exchange information and negotiate a number of ranging parameters and capabilities such as, for example, a capability of capturing timestamping, a capability of estimating angle information, a frame format to be used for exchanging ranging frames, a bandwidth with which to transmit ranging frames, a duration of the ranging operation, a periodicity of the ranging operation, the number of frame exchanges or “bursts” for each ranging operation, and so on.

The STA may initiate the negotiation phase 420 by transmitting an FTM request (FTM_REQ) frame to the AP. In addition to signaling or requesting the ranging operation 400, the FTM_REQ frame may request the number of ranging parameters and capabilities. The AP receives the FTM_REQ frame, and may acknowledge the requested ranging operation by transmitting an acknowledgement (ACK) frame to the STA. The ACK frame may indicate the AP's capabilities (such as whether the AP is capable of capturing timestamps, capable of transmitting in the requested frame format and bandwidth, and so on), and may accept a number of the ranging parameters requested by the STA.

During the measurement phase 430, the STA and the AP may exchange a number of ranging or “measurement” frames. If both the AP and the STA support the FTM protocol, then the measurement phase 430 may be performed by exchanging a number of FTM frames. For example, at time t₁, the AP transmits an FTM_1 frame to the STA, and may capture the TOD of the FTM_1 frame as time t₁. The STA receives the FTM_1 frame at time t₂, and may capture the TOA of the FTM_1 frame as time t₂. The STA responds by transmitting a first acknowledgement (ACK1) frame to the AP at time t₃, and may capture the TOD of the ACK1 frame as time t₃. The AP receives the ACK1 frame at time t₄, and may capture the TOA of the ACK1 frame as time t₄. At time t₅, the AP transmits to the STA an FTM_2 frame that includes the timestamps captured at times t₁ and t₄ (such as the TOD of the FTM_1 frame and the TOA of the ACK1 frame). The STA receives the FTM_2 frame at time t₆, and may capture its timestamp as time t₆.

Upon receiving the FTM_2 frame at time t₆, the STA has timestamp values for times t₁, t₂, t₃, and t₄ that correspond to the TOD of the FTM_1 frame transmitted from the AP, the TOA of the FTM_1 frame at the STA, the TOD of the ACK1 frame transmitted from the STA, and the TOA of the ACK1 frame at the AP, respectively. Thereafter, the STA may determine an RTT value as RTT=(t₄−t₃)+(t₂−t₁). Because the value of RTT does not involve estimating SIFS for either the STA or the AP, the value of RTT does not involve errors resulting from uncertainties in SIFS durations.

Wi-Fi ranging operations may be performed using frames transmitted as orthogonal frequency-division multiplexing (OFDM) symbols. The accuracy of RTT estimates may be proportional to the number of tones (such as the number of OFDM sub-carriers) used to transmit the ranging frames. For example, while a legacy frame may be transmitted on a 20 MHz-wide channel using 52 tones, a high-throughput (HT) frame or a very high-throughput (VHT) frame may be transmitted on a 20 MHz-wide channel using 56 tones, and a high-efficiency (HE) frame may be transmitted on a 20 MHz-wide channel using 242 tones. Thus, for a given frequency bandwidth or channel width, HT/VHT/HE frames use more tones than non-HT frames, and may therefore provide more accurate channel estimates and RTT estimates than non-HT frames.

The IEEE 802.11ax specification may introduce multiple access mechanisms, such as an orthogonal frequency-division multiple access (OFDMA) mechanism, to allow multiple STAs to transmit and receive data on a shared wireless medium at the same time. For a wireless network using OFDMA, the available frequency spectrum may be divided into a plurality of resource units (RUs) each including a number of different frequency subcarriers, and different RUs may be allocated or assigned (such as by an AP) to different wireless devices (such as STAs) at a given point in time. In this manner, multiple wireless devices may concurrently transmit data on the wireless medium using their assigned RUs or frequency subcarriers.

In some implementations, an AP may use a trigger frame to allocate specific RUs to a number of wireless devices identified in the trigger frame. The trigger frame may indicate the RU size and location, the MCS, and the power level to be used by the identified wireless devices for UL transmissions. In some other implementations, the AP may use a trigger frame to solicit uplink (UL) multi-user (MU) data transmissions from a number of wireless devices identified in the trigger frame. In some implementations, the trigger frame may indicate or specify an order in which the identified wireless devices are to transmit UL data to the AP.

FIG. 5A shows a signal diagram of another example ranging operation 500, FIG. 5B shows a timing diagram 510 of the ranging operation 500 of FIG. 5A, and FIG. 5C shows a signal diagram of a passive positioning operation 530. The ranging operation 500 is performed between a first access point (AP0) operating as an initiator device and a number of other access points (AP1-APn) operating as responder devices. For the example ranging operation 500, the access point AP0 is referred to as the initiator device based on its role in announcing the passive ranging schedule to the other access points AP1-APn, and the other access points AP1-APn are referred to as responder devices based on their responding to the trigger frame transmitted by the access point AP0. In some other implementations, the other access points AP1-APn may be referred to as the initiator devices based on their roles in transmitting UL frames, and the first access points AP0 may be referred to as the responder device based on its role in transmitting DL frames. The STA may listen to the frame exchanges between the initiator device AP0 and the responder devices AP1-APn, and passively determine its location.

The access points AP0-APn of FIG. 5A may be any suitable AP including, for example, the AP 110 of FIG. 1 or the AP 200 of FIG. 2. In some other implementations, the initiator device AP0 or one or more of the responder devices AP1-APn each may be another suitable wireless device including, for example, one of the STAs 120a-120i of FIG. 1 or the STA 300 of FIG. 3. The STA may be any suitable wireless device including, for example, one of the STAs 120a-120i of FIG. 1 or the STA 300 of FIG. 3. Although only one passive listening device (such as the STA) is shown in the examples of FIGS. 5A and 5C, in some other implementations, any number of passive listening devices may listen to frames exchanged in the ranging operation 500 to passively determine their locations at the same time (or at substantially the same time).

The ranging operation 500 may be associated with or include a discovery phase, a negotiation phase, and a measurement phase. For example, during the discovery phase, the initiator device AP0 may discover other wireless devices that support ranging operations (such as the responder devices AP1-APn of FIG. 5A), and may indicate its ability to support features of the IEEE 802.11ax and 802.11az specifications to the responder devices AP1-APn. The capability to support the IEEE 802.11ax and IEEE 802.11az specification may be included in an extended capabilities IE (or field), may be a reserved bit in an existing capabilities IE, may be included in a vendor-specific information element (VSIE), or in any other suitable field or IE of a frame. In some implementations, the discovery phase of FIG. 5A may be similar to the discovery phase 410 of FIG. 4.

During the negotiation phase, the initiator device AP0 may announce a passive ranging schedule to the responder devices AP1-APn and to any nearby passive listening devices (such as the STA). In some implementations, the initiator device AP0 may include the passive ranging schedule in beacon frames (along with its location and also the location of other devices with which the device has negotiated the ranging operation), which also may include the TSF value and the beacon interval of the initiator device AP0. In some implementations, the initiator device AP0 may periodically embed the passive ranging schedule within beacon frames (such as within every N^{th} beacon frame, where N is an integer greater than one). Each beacon frame may include a “NeighborReport Count” (NC) field that stores a counter value indicating whether the beacon frame contains the passive ranging schedule. For example, when the passive ranging schedule is contained in every N^{th} beacon frame, the initiator device AP0 may set the counter value to an initial value of N, and decrement the counter value (by one) upon transmission of each beacon frame such that a beacon frame having a counter value of zero stored in its NC field is the beacon frame that includes the passive ranging schedule. In some other implementations, each of the responder devices AP1-APn and passive listening devices may include a local counter that is initialized to a value of N, and decrement its local counter (by one) each time a beacon frame is transmitted from the initiator device AP0. In this manner, each receiving device (such as the responder devices AP1-APn and STAs) may determine which beacon frame contains the passive ranging schedule (such as when their local counters equal zero). In addition, or as an alternative, the initiator device AP0 may include the passive ranging schedule in all beacon frames. Also, it is possible that the responder devices AP1-APn announce the schedules of the passive ranging operations in which they participate.

In some other implementations, the initiator device AP0 may include the passive ranging schedule in probe responses. In some implementations, the initiator device AP0 may include the passive ranging schedule in all probe responses. In still other implementations, the initiator device AP0 may include the passive ranging schedule in selected probe responses, for example, that are transmitted in response to probe requests that include a query or request for the passive ranging schedule. The query or request for the passive ranging schedule may be included within any suitable field or bits of the probe requests. Alternately, announcing the passive ranging schedule may be two-step process, for example, where the probe response signals support for passive ranging operations, and the device receiving the probe response can send a request for the passive ranging schedule. The request may be a separate frame, or an FTM Request frame with a specific Trigger Value to signal the request for the passive ranging schedule.

In some implementations, the passive ranging schedule may include the following fields:
a Scheduling field indicating the time of each ranging operation, the duration of each ranging operation, and an interval between ranging operations;
a Participant field including at least one of an identity of each device participating in the ranging operation, an indication of whether each of the identified participant devices is an access point or a client device, and an indication of whether each of the identified participant devices is to operate as the initiator device or as one of the responder devices;
a Parameters field including at least one of a type of frames to be exchanged during the ranging operation, a number of antennas to be used by the responder devices during the ranging operation, a frequency bandwidth to be used for transmitting the frames, a wireless channel to be used for the ranging operation, a capability to capture timestamps (such as TOD and TOA values) of the frames, and a capability to estimate angle information (such as AoD and AoA information) of the frames; and
a Location field indicating the location of the initiator device AP0 and the responder devices AP1-APn that will participate in the scheduled ranging operations.

The Scheduling field may indicate a time either before or after the transmission of a given beacon frame from the initiator device AP0 at which the ranging operation is to commence. In some implementations, the initiator device AP0 may schedule each frame exchange of the ranging operation 500 to begin a time period prior to a corresponding TBTT, for example, so that each frame exchange between the initiator device AP0 and the responder devices AP1-APn is completed prior to the transmission of a next beacon frame from the initiator device AP0. In this manner, frame exchanges associated with the ranging operation 500 may not interfere with beacon frame transmissions from the initiator device AP0. Additionally, by completing a frame exchange with the responder devices AP1-APn prior to a given TBTT, the initiator device AP0 may include timing information (such as timestamps captured by the initiator device AP0) of the frame exchange into the next beacon frame.

The Participant field may identify participating wireless devices using AID values of associated STAs, BSSID values of APs, MAC addresses, or any other suitable identifying information. In some implementations, the Participant field also may indicate whether each of the identified participant devices is an access point or a client device, and whether each of the identified participant devices is to operate as an initiator device or as a responder device.

The Parameters field may indicate any suitable type of frames to be exchanged between the initiator device AP0 and the responder devices AP1-APn. In some implementations, the initiator device AP0 and the responder devices AP1-APn may exchange null data packets (NDP) that contain a number of sounding sequences from which multiple RTT values may be obtained from each frame exchange, for example, as depicted in the example ranging operation 500 of FIGS. 5A and 5B. In some other implementations, the ranging operation 500 may be performed by exchanging enhanced FTM frames (eFTM frames) between the initiator device AP0 and the responder devices AP1-APn. As used herein, eFTM frames may refer to FTM frames that have been modified (such as compared with the FTM frames defined by the IEEE 802.11REVmv standards) to include a number of additional sounding sequences from which a corresponding number of additional RTT values may be obtained from each frame exchange. In some implementations, the number of additional sounding sequences may be contained in a packet extension of an HE packet that encapsulates the FTM frame.

The Parameters field also may indicate a frequency bandwidth to be used by the initiator device and the responder devices when transmitting frames during the ranging operation, may indicate a capability to capture timestamps of transmitted frames, may indicate a capability to estimate TOA values of received frames, may indicate a capability to determine TOD values of transmitted frames, and may indicate a capability to estimate angle information (such as AoD and AoA information) of received frames.

The Location field may indicate the locations of the initiator device AP0 and the responder devices AP1-APn in any suitable manner In some implementations, the locations may be location civic information (LCI) values (which are expressed as longitude and latitude coordinates). In some other implementations, the locations may be location civic values expressed as a mailing address.

In addition, or in the alternative, the passive ranging schedule also may include the following fields:
a Channel field identifying one or more channels upon which the scheduled ranging operations are to be performed;
a Clock field selecting the clock domain in which the ranging operations are scheduled;
a Synchronization field including mappings between the clock domains of the initiator device AP0, the participating responder devices AP1-APn, and the selected clock domain; and
a Beacon field indicating the TBTTs of the participating responder devices AP1-APn.

The Channel field may identify a single channel or multiple channels to be used for ranging operations, and may indicate a frequency bandwidth of the identified channel(s). In some implementations, the initiator device AP0 may specify that ranging operations (such as the ranging operation 500) will be performed on the channel used by its BSS, for example, so that STAs associated with the initiator device AP0 can stay on the same channel. In these implementations, the responder devices AP1-APn may switch to the specified channel to participate in the scheduled ranging operations, and thereafter return to their normal operating channels. In some other implementations, the initiator device AP0 may specify that ranging operations (such as the ranging operation 500) will be performed on multiple channels. In these implementations, the passive ranging schedule also may indicate channel switching information that indicates specific times at which each of the responder devices AP1-APn and the passively listening devices (such as the STA) is to switch wireless channels (such as when to switch from a first specified wireless channel to a second specified wireless channel). In some implementations, the specified channel switching times may be based on (or referenced to) the TSF value of the initiator device AP0.

Additionally, in some other implementations, the negotiation phase and the measurement phase of the ranging operation 500 may be performed on different channels.

The Synchronization field may include mappings between the clock domains of the initiator device AP0, the participating responder devices AP1-APn, and the selected clock domain. In some implementations, the mappings may indicate clock offset values between the clock domains of the initiator device AP0 and the responder devices AP1-APn. For example, the initiator device AP0 and the responder devices AP1-APn may be associated with different wireless networks (such as different BSSs), and therefore may have different TSF values at any given time. The mappings contained in the Synchronization field may be used by the responder devices AP1-APn to learn or predict the TSF value of the initiator device AP0, for example, so that the responder devices AP1-APn know when the scheduled frame exchanges are to begin and so that the responder devices AP1-APn can coordinate their own TSF values with the TSF value of the initiator device AP0 when determining RTT values based on the frame exchanges.

After the discovery and negotiation phases are complete, the initiator device AP0 may begin the measurement phase. In some implementations, the first frame exchange 501 may substantially coincide with a first beacon interval 512A of the initiator device AP0, for example, as depicted in FIG. 5B. For the example ranging operation 500, the initiator device AP0 may transmit a downlink null data packet announcement (DL NDPA) to the responder devices AP1-APn. The DL NDPA may announce that the initiator device AP0 is initiating a first frame exchange 501, and inform the responder devices AP1-APn to listen for an NDP.

At time t₁, the initiator device AP0 transmits the DL NDP to the responder devices AP1-APn, and may capture the TOD of the DL NDP as time t₁. In some implementations, transmission of the NDPA and the NDP may be separated by a SIFS duration. The DL NDP may include a number of sounding sequences from which multiple RTT values may be obtained. The sounding sequences contained in the DL NDP may be high-efficiency long training fields (HE-LTFs), very high-throughput long training fields (VHT-LTFs), high-throughput long training fields (HT-LTFs), or legacy LTFs. In some implementations, the sounding sequences may be orthogonal to each other, for example, so that the responder devices AP1-APn can distinguish between sounding sequences transmitted from different antennas of the initiator device AP0.

The responder devices AP1-APn receive the DL NDP at times t_{2,1} through t_{2,n}, respectively, and may capture the corresponding TOAs. Each of the responder devices AP1-APn may obtain separate TOA values from each of the sounding sequences contained in the DL NDP. In some implementations, the responder devices AP1-APn may estimate channel conditions and derive angle information from the sounding sequences contained in the DL NDP.

The initiator device AP0 transmits a trigger frame to the responder devices AP1-APn. In some implementations, the initiator device may transmit a multi-user (MU) trigger frame to the responder devices AP1-APn. In some other implementations, the initiator device may transmit a single-user (SU) trigger frame to each of the responder devices AP1-APn. The trigger frame may inform each of the responder devices AP1-APn that the ranging operation 500 has been initiated, and may solicit each of the responder devices AP1-APn to transmit an UL MU-NDP to the initiator device AP0.

Additionally, the trigger frame may include or indicate scheduling information and grouping information for the ranging operation 500. In some implementations, the initiator device AP0 may divide the responder devices AP1-APn into a number of different groups, for example, based on available channel resources, available resources (such as the number of antennas) of the initiator device AP0, ranging parameters requested by the responder devices AP1-APn (such as the minimum number of antennas requested by each of the responder devices AP1-APn), or a combination thereof. The initiator device AP0 also may schedule different responder devices AP1-APn or different groups of responder devices AP1-APn at different times (such as in a staggered manner), and may inform the responder devices AP1-APn or groups of responder devices AP1-APn when to wake up for their scheduled ranging operation 500.

At time t₃, the responder devices AP1-APn transmit UL MU NDPs to the initiator device AP0, and may capture the TOD of the UL MU NDPs as time t₃. Each of the UL MU-NDPs may include a number of sounding sequences from which multiple RTT values may be obtained (and from which channel conditions may be estimated). The sounding sequences contained in each of the UL MU-NDPs may be HE-LTFs, VHT-LTFs, HT-LTFs, or legacy LTFs. In some implementations, the sounding sequences may be orthogonal to each other, for example, so that the initiator device AP0 can distinguish between sounding sequences transmitted from different antennas of a given one of the responder devices AP1-APn.

In some implementations, the initiator device AP0 may embed sounding sequences into the DL NDP according to the P-matrix depicted in FIG. 11. Similarly, the responder devices AP1-APn may embed sounding sequences into the UL MU NDPs according to the P-matrix depicted in FIG. 11. In some implementations, each of the UL MU NDPs transmitted from the responder devices AP1-APn may include a common header.

The initiator device AP0 receives the UL MU-NDPs at times t_{4,1} through t_{4,n}, respectively, and may record the TOA of the UL MU-NDPs. The UL MU-NDPs transmitted from the responder devices AP1-APn may arrive at the initiator device AP0 at different times, for example, because the distances between the initiator device AP0 and each of the responder devices AP1-APn may be different.

At time t₅, the initiator device AP0 transmits a first beacon frame to the responder devices AP1-APn, for example, according to the TBTT schedule of the initiator device AP0. The beacon first frame, which is received by the responder devices AP1-APn at times t_{6,1} through t_{6,n}, respectively, may include timestamp values for t₁ (which corresponds the TOD of the DL NDP) and t_{4,1} to t_{4,n} (which correspond to the TOAs of the UL MU-NDPs received from the responder devices AP1-APn, respectively. The ability to transmit timestamp values for t₁ and t_{4,1} to t_{4,n} in the beacon frame (which is typically broadcast by the initiator device AP0 irrespective of the ranging operation 500) may obviate the need for a separate frame in the first exchange 501 to provide the timing information to the responder devices AP1-APn.

Upon reception of the first beacon frame, each of the responder devices AP1-APn has timestamp values for t1, t₂, t₃, and t_{4,1} to t_{4,n} and may determine the RTT between itself and the initiator device AP0 using the expression RTT=(t₄ −t₃)+(t₂−t₁). For example, the first responder device AP1 can determine RTT values using the expression RTT=(t_{4,1}−t₃)+(t_{2,1}−t₁), the second responder device AP2 can determine RTT values using the expression RTT=(t_{4,2}−t₃)+(t_{2,2}−t₁), and the n^{th} responder device APn can determine RTT values using the expression RTT=(t_{4,n}−t₃)+(t_{2,n}−t₁).

Although not depicted in FIG. 5A, the first beacon frame also may contain or indicate angle information and location information. The angle information may include AoD information of the DL NDP transmitted from the initiator device AP0, AoA information of the UL MU-NDPs received by the initiator device AP0, or both. The location information may include the location of the initiator device AP0, the locations of one or more the responder devices AP1-APn, or any combination thereof.

As depicted in FIG. 5B, the first exchange of NDPs between the initiator device AP0 and the responder devices AP1-APn may occur during the first beacon interval 512A of the initiator device AP0. One or more additional exchanges of NDPs (or other suitable ranging frames) may occur during one or more subsequent beacon intervals. For example, as shown in FIGS. 5A and 5B, the initiator device AP0 and the responder devices AP1-APn may perform a second frame exchange 502 between times t₇ and t₁₀, which may correspond to a second beacon interval 512B of the initiator device AP0. The second frame exchange 502 may be similar to (or the same) as the first frame exchange 501). The initiator device AP0 may transmit a second beacon frame containing timestamps for t₇ and t₁₀ to the responder devices AP1-APn at time t₁₁, for example, at the second TBTT (as depicted in FIG. 5B).

In some other implementations, the initiator device AP0 may perform the second frame exchange 502 (or other frame exchanges) with another set of responder devices (such as APs different than AP1-APn depicted in FIGS. 5A and 5B) during the second beacon interval 512B. In this manner, the initiator device AP0 may perform ranging operations with different sets of responder devices during different beacon intervals. In some implementations, the initiator device AP0 may use different channels to perform different frame exchanges during various beacon intervals.

As a passive listening device, the STA may receive all of the frames exchanged between the initiator device AP0 and the responder devices AP1-APn. For example, the STA may receive the first DL NDP transmitted from the initiator device AP0 at time tₚ₁, may receive the first UL MU NDPs transmitted from the responder devices AP1-APn at times t_{p2,1} to t_{p2,n}, may receive the second DL NDP transmitted from the initiator device AP0 at time tₚ₃, and may receive the second UL MU NDPs transmitted from the responder devices AP1-APn at times t_{p4,1} to t_{p4,n}. In some implementations, the STA may receive the first beacon frame transmitted from the initiator device AP0 and extract timestamps for time t₁ and times t_{4,1} to t_{4,n}, and also may receive the second beacon frame transmitted from the initiator device AP0 and extract timestamps for time t₇ and times t_{10,1} to t_{10,n}. The STA may use the timestamps corresponding to different sets of times t₁-t₄ to passively determine its location based on the differences in distance between the STA and each of the access points AP0-APn.

Referring to FIG. 5C, the STA receives a first UL MU-NDP from AP1 at time t_{p2,1}, and receives a second UL MU NDP from AP2 at time t_{p2,2}. The STA receives the first DL NDP transmitted from the initiator device AP0 at time tₚ₁. The STA may use the captured timestamps t_{p2,1}, t_{p2,2}, and tₚ₁ corresponding to the reception of the first UL MU-NDP, the second UL MU-NDP, and the first DL NDP, respectively, and the timestamps for times t_{4,1} to t_{4,n} and time t₃ provided by the DL FB frame to calculate a number of differential distances between itself and the access points AP0-AP2. In some implementations, the STA may calculate the differential distance (D1) between itself and each of AP0 and AP1 using the expression:

D1=[tₚ₁−(t_{p2,1}−(t_{4,1}−t₁−ToF₁))]*c,

where ToF₁ is the time-of-flight between AP0 and AP1, and c is the speed of light (such as ToF₁ is one-half the RTT between AP0 and AP1).

Similarly, the STA may calculate the differential distance (D2) between itself and each of AP0 and AP2 using the expression:

D2=[tₚ₁−t_{p2,2}−(t_{4,2}−t₁+ToF₂)]*c,

where ToF₂ is the time-of-flight between AP0 and AP2, and c is the speed of light. Although not shown for simplicity in FIG. 5C, the STA may calculate the differential distance between itself and AP0 and APn in a similar manner, and then use well-known hyperbolic navigation techniques to determine its location. Because the STA does not transmit any frames (but rather listens to the NDPs exchanged between the access points AP0-APn), the STA may determine its location using less power (such as compared to active ranging operations), as well to as avoid revealing its own location (for examples in which the STA is implemented solely to receive frames).

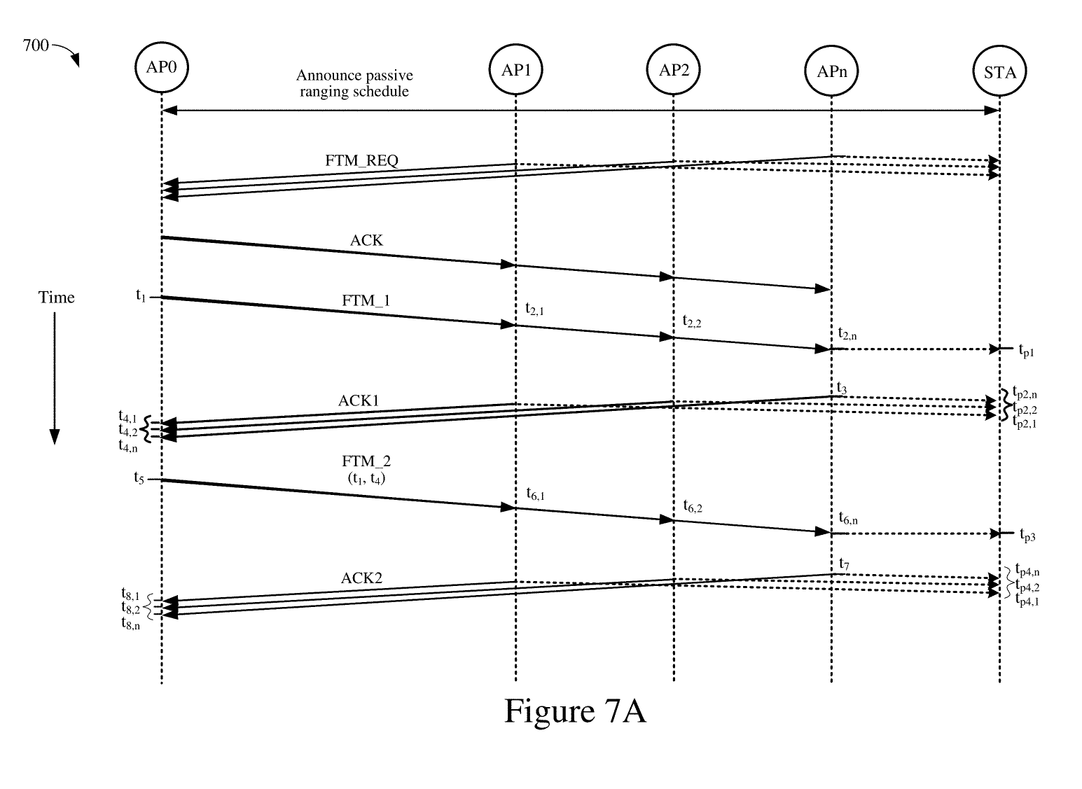

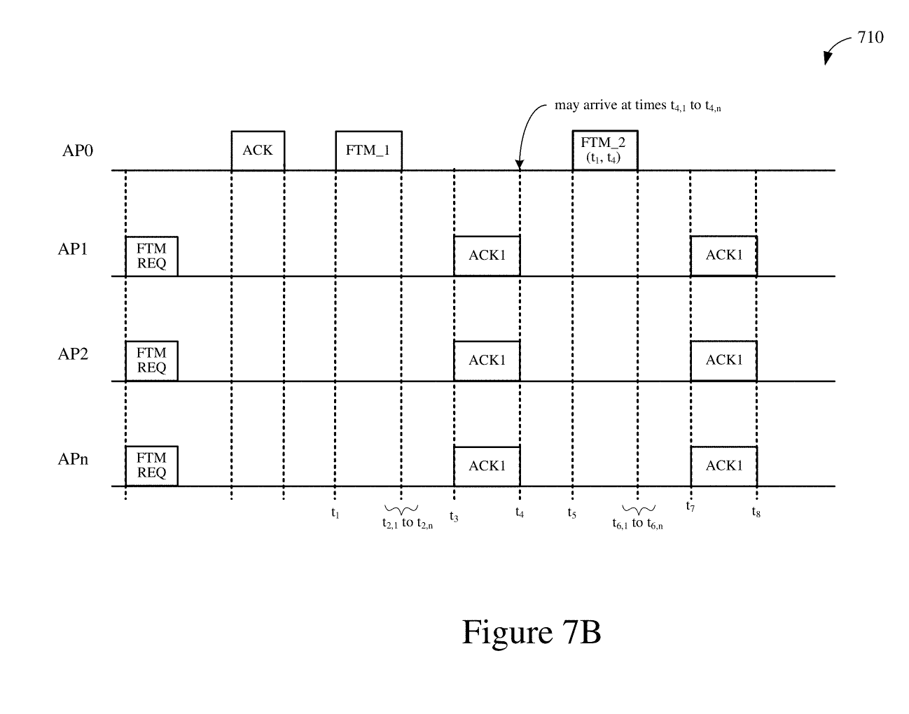

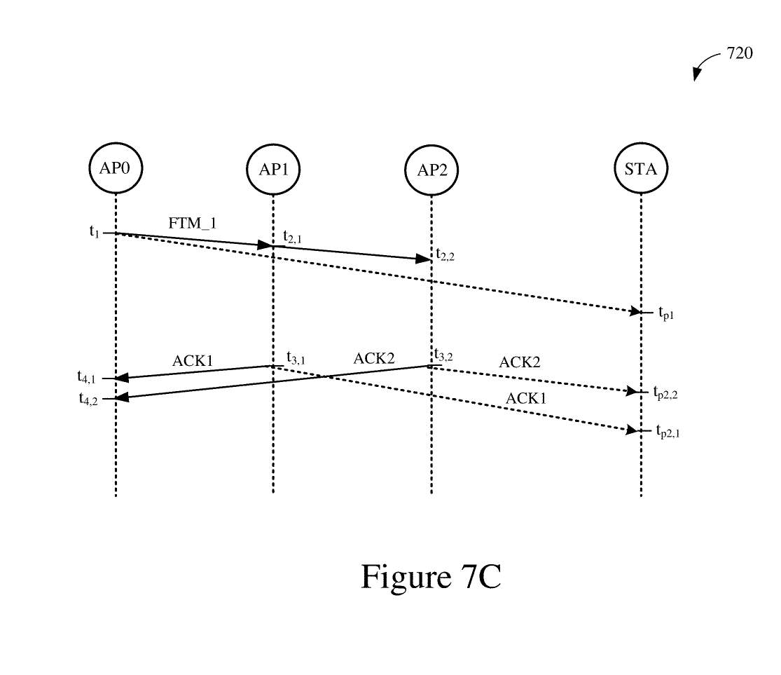

In some implementations, the responder devices AP1-APn may transmit the UL MU NDPs in a staggered manner FIG. 5D shows a timing diagram of a staggered uplink data transmission 530 for the ranging operation of FIG. 5A. The staggered UL data transmission 530 may be one implementation of the UL MU NDP transmissions from the responder devices AP1-APn in the example ranging operation 500 of FIGS. 5A and 5B. As depicted in FIG. 5D, the initiator device AP0 transmits a DL NDP at time t₁, followed by the trigger frame. The responder devices AP1-APn then sequentially transmit the UL MU NDPs to the initiator device AP0. For example, AP1 transmits its UL MU NDP to the initiator device AP0 at time t₃₍₁₎, AP2 transmits its UL MU NDP to the initiator device AP0 at time t₃₍₂₎, and so on, where APn transmits its UL MU NDP to the initiator device AP0 at time t₃₍ₙ₎. In some implementations, each of the times t₃₍₁₎ through t₃₍ₙ₎ is separated by a SIFS duration, as depicted in FIG. 7A. Staggering the transmission of the UL NDPs from the responder devices AP1-APn (such as separating successive UL transmissions by a SIFS duration) may allow the initiator device AP0 sufficient time to distinguish between the UL NDPs received from the responder devices AP1-APn. The frame-based staggered UL transmission 530 depicted in FIG. 5D may allow for variations in timing synchronization between the access points AP0-APn.

In some other implementations, the responder devices AP1-APn may transmit the UL MU NDPs using interleaved symbols. FIG. 5E shows a timing diagram of a symbolled interleaved uplink data transmission 540 for the ranging operation of FIG. 5A. The symbol interleaved UL data transmission 540 may be one implementation of the UL MU NDP transmissions from the responder devices AP1-APn in the example ranging operation 500 of FIGS. 5A and 5B. As depicted in FIG. 5E, the initiator device AP0 transmits a DL NDP at time t₁, followed by a trigger frame. The responder devices AP1-APn may transmit the UL MU NDPs to the initiator device AP0 at times t_{3,1} to t_{3,n} as UL MU-MIMO data, for example, such that the HE NDP header contains the HE-STF and HE-LTF from AP1, followed by the HE-STF and HE-LTF from AP2, followed by the HE-STF and HE-LTF from AP3. The symbol-interleaved UL data transmission 710 allows the responder devices AP1-APn to utilize the full bandwidth of the wireless medium, and its accuracy may be more dependent upon timing synchronization between the access points AP0-APn (such as compared to the staggered UL transmission 540 of FIG. 5E), and the time stamps correspond to the actual start of transmission and reception of the portion of the frame i.e., HE-STF+HE-LTF or HE-LTF, transmitted by responder devices AP1-APn. In some implementations, the packet header in each UL MU NDP reserves the wireless medium for the duration of the packet.

In some other implementations, the initiator device AP0 may perform ranging operations with the responder devices AP1-APn using an FTM protocol (such as rather than exchanging NDPs as depicted in the ranging operation 500 of FIG. 5A).

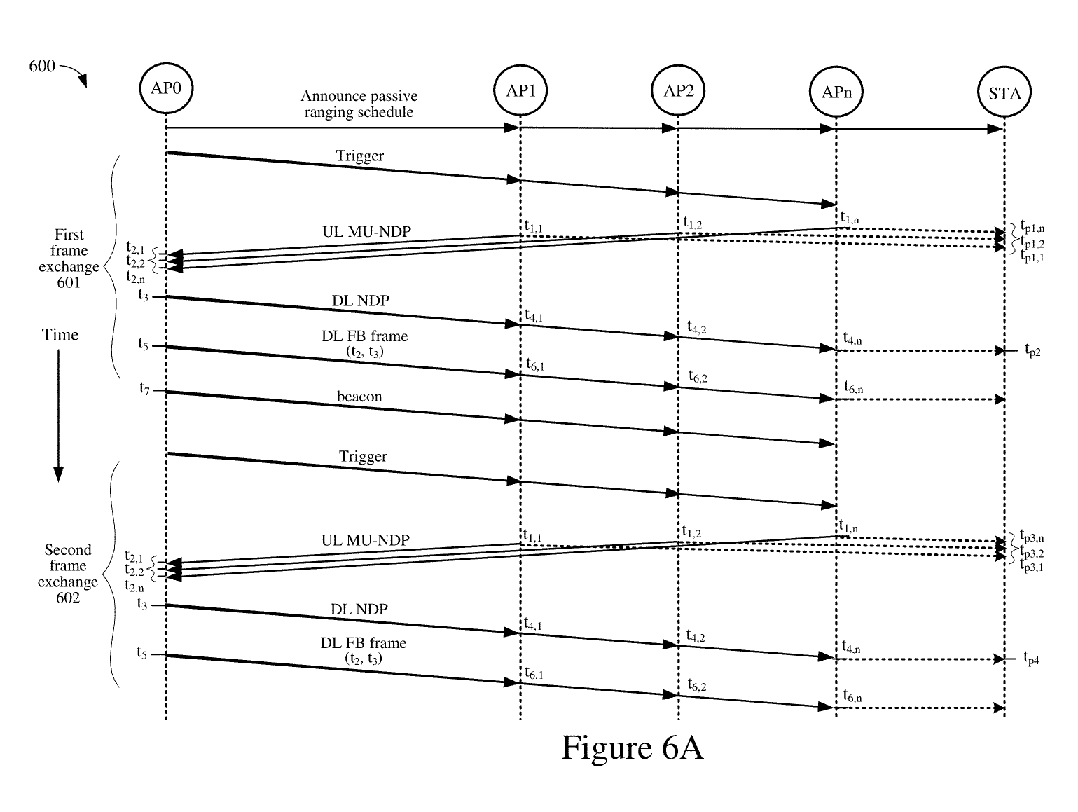

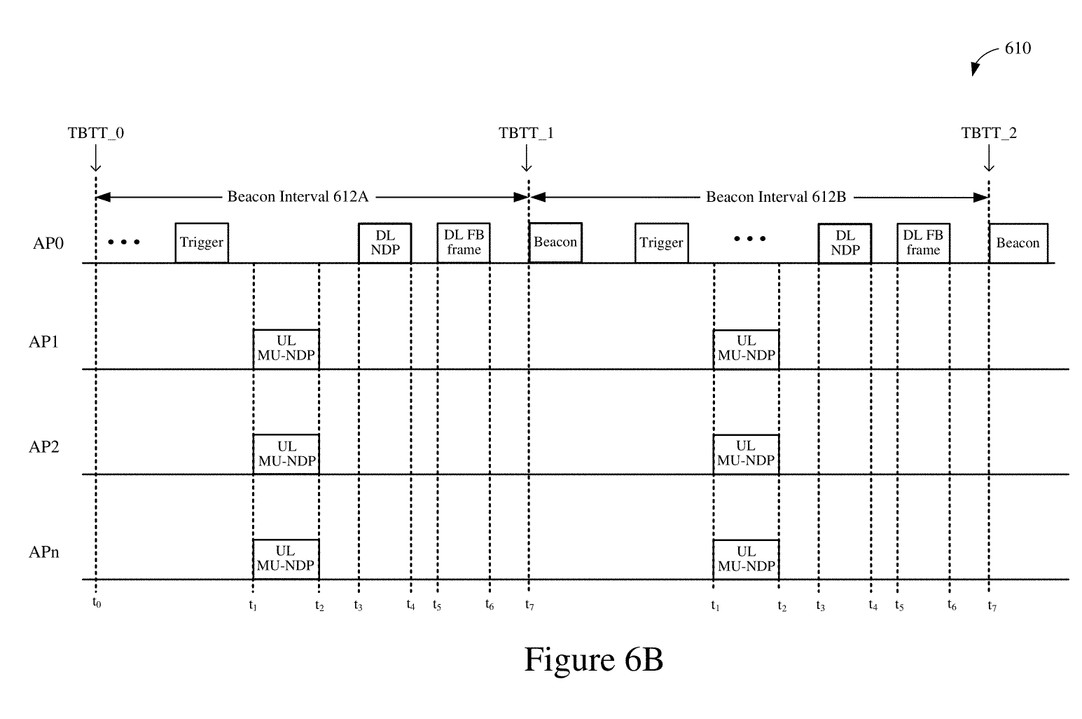

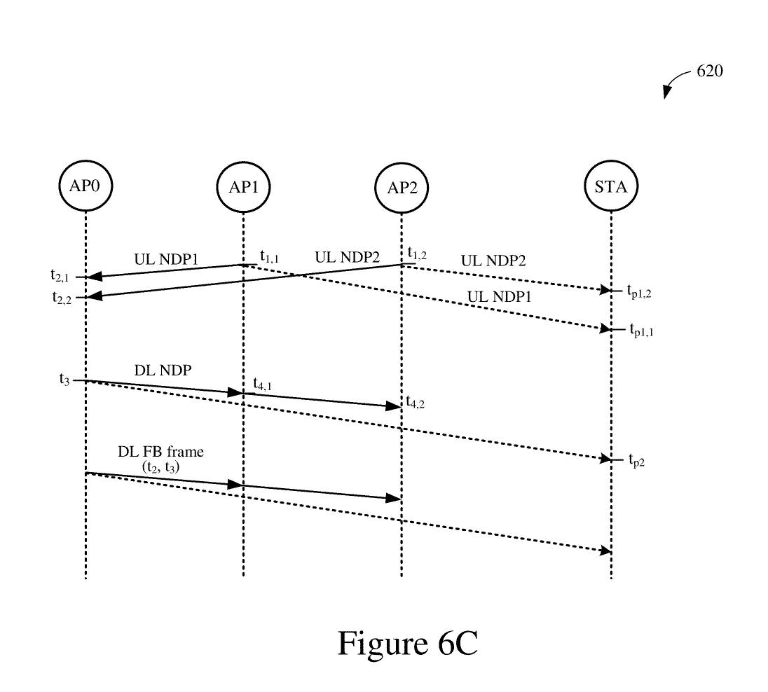

FIG. 6A shows a signal diagram of another example ranging operation 600, FIG. 6B shows a timing diagram 610 of the ranging operation 600 of FIG. 6A, and FIG. 6C shows a signal diagram of a passive positioning operation 630. The ranging operation 600 is performed between a first access point (AP0) operating as an initiator device and a number of other access points (AP1-APn) operating as responder devices. The STA may listen to the frame exchanges between the initiator device AP0 and the responder devices AP1-APn, and passively determine its location.

The access points AP0-APn of FIG. 6A may be any suitable AP including, for example, the AP 110 of FIG. 1 or the AP 200 of FIG. 2. In some other implementations, the initiator device or one or more of the responder devices each may be another suitable wireless device including, for example, one of the STAs 120a-120i of FIG. 1 or the STA 300 of FIG. 3. The STA may be any suitable wireless device including, for example, one of the STAs 120a-120i of FIG. 1 or the STA 300 of FIG. 3. Although only one passive listening device (such as the STA) is shown in the examples of FIGS. 6A and 6C, in some other implementations, any number of passive listening devices may listen to frames exchanged in the ranging operation 600 to passively determine their locations at the same time (or at substantially the same time).

The ranging operation 600 may be associated with or include a discovery phase and a negotiation phase similar that described above with respect to the ranging operation 500 of FIG. 5A. For example, in some implementations, the initiator device AP0 may announce the passive ranging schedule, a number of capabilities, and a number of ranging parameters in beacon frames. In some other implementations, the initiator device AP0 may announce the passive ranging schedule, a number of capabilities, and a number of ranging parameters in probe response frames.

During a measurement phase, the initiator device AP0 transmits an MU trigger frame to the responder devices AP1-APn. The MU trigger frame may inform each of the responder devices AP1-APn that the ranging operation 600 has been initiated, and may solicit each of the responder devices AP1-APn to transmit an UL MU-NDP to the initiator device AP0. In some implementations, the MU trigger frame serves as an implicit NDPA for the DL NDP to be transmitted from the initiator device AP0 at time t₃, thereby eliminating the need to transmit a separate NDPA to the responder devices AP1-APn.

Additionally, the MU trigger frame may include or indicate scheduling information and grouping information for the ranging operation 600. In some implementations, the initiator device AP0 may divide the responder devices AP1-APn into a number of different groups, for example, based on available channel resources, available resources (such as the number of antennas) of the initiator device AP0, ranging parameters requested by the responder devices AP1-APn (such as the minimum number of antennas requested by each of the responder devices AP1-APn), or a combination thereof. The initiator device AP0 also may schedule different responder devices AP1-APn or different groups of responder devices AP1-APn at different times (such as in a staggered manner), and may inform the responder devices AP1-APn or groups of responder devices AP1-APn when to wake up for their scheduled ranging operation 600.

The responder devices AP1-APn receive the MU trigger frame, and decode the MU trigger frame to determine which wireless devices are identified for UL transmissions (and to determine any scheduling and grouping information that may be included in the MU trigger frame). At times t_{1,1} to t_{1,n}, each of respective responder devices AP1-APn transmits an UL MU-NDP to the initiator device AP0, and captures the TOD of the UL MU-NDP. The UL MU-NDPs may include a number of sounding sequences from which multiple RTT values may be obtained (and from which channel conditions may be estimated). The sounding sequences contained in the UL MU-NDPs may be HE-LTFs, VHT-LTFs, HT-LTFs, or legacy LTFs. The sounding sequences may be orthogonal to each other. In some implementations, the sounding sequences transmitted in the UL MU-NDPs may be selected using the P-matrix shown in FIG. 11. Additionally, each of the UL MU-NDPs transmitted from the triggered responder devices AP1-APn may include a common header.

The initiator device AP0 receives the UL MU-NDPs transmitted from responder devices AP1-APn at times t_{2,1} to t_{2,n}, respectively, and may capture the TOAs of the UL MU-NDPs. In some implementations, the initiator device AP0 may estimate angle information based on the sounding sequences contained in the UL MU-NDPs.

At time t₃, the initiator device AP0 transmits a DL NDP to the responder devices AP1-APn, and may record the TOD of the DL NDP as time t₃. The DL NDP may include a number of sounding sequences from which multiple RTT values may be obtained (and from which channel conditions may be estimated). The sounding sequences contained in the DL NDP may be HE-LTFs, VHT-LTFs, HT-LTFs, or legacy LTFs. The sounding sequences in the DL NDP may be orthogonal to each other. In some implementations, the sounding sequences transmitted in the UL MU-NDPs may be selected using the P-matrix shown in FIG. 11.

Although not shown in FIGS. 6A and 6B for simplicity, in some implementations, the DL NDP also may include a NDPA that announces the DL NDP. In some other implementations, the initiator device AP0 may transmit a separate DL NDPA to the responder devices AP1-APn, for example, a SIFS duration prior to the transmission of the DL NDP to the responder devices AP1-APn.

The responder devices AP1-APn receive the DL NDP at times t_{4,1} to t_{4,n}, respectively, and may capture the TOAs as times t_{4,1} to t_{4,n}, respectively. In some implementations, the responder devices AP1-APn may estimate angle information of the DL NDP based on the sounding sequences contained therein.

At time t₅, the initiator device AP0 transmits a downlink feedback (DL FB) frame to the responder devices AP1-APn. The DL FB frame may be any suitable frame or frames including, for example, a number of single-user (SU) trigger frames, a multi-user (MU) trigger frame, a number of SU measurement feedback frames, an MU measurement feedback frame, a number of SU response frames, an MU response frame, and the like. The DL FB frame, which is received by the responder devices AP1-APn at times t_{6,1} through t_{6,n}, respectively, may include timestamp values for times t_{2,1} to t_{2,n} and time t₃ that correspond to the TOAs of the UL MU-NDPs received at the initiator device AP0 and the TOD of the DL NDP transmitted from the initiator device AP0. Upon reception of the DL FB frame, each of the responder devices AP1-APn has timestamp values for t₁, t₂, t₃, and t₄, and may determine the RTT between itself and the initiator device AP0 using the expression RTT=(t₄−t₃)+(t₂−t₁). More specifically, the first responder device AP1 may determine RTT values using the expression RTT=(t_{4,1}−t₃)+(t_{2,1}−t_{1,1}), the second responder device AP2 may determine RTT values using the expression RTT=(t_{4,2}−t₃)+(t_{2,2}−t_{1,1}), and the n^{th} responder device APn may determine RTT values using the expression RTT=(t_{4,n}−t₃)+(t_{2,n}−t_{1,n}).

It is noted that one of differences between the ranging operation 500 and the ranging operation 600 is that for the ranging operation 500, the initiator device AP0 captures timestamp values for times t₁ and t₄, and then transmits timing information for times t₁ and t₄ to the responder devices AP1-APn. In contrast, for the ranging operation 600, the initiator device AP0 captures timestamp values for times t₂ and t₃, and then transmits timing information for times t₂ and t₃ to the responder devices AP1-APn.

Although not depicted in FIG. 6A, the DL FB frame also may contain or indicate angle information and location information. The angle information may include AoD information of the UL MU-NDPs transmitted from the responder devices AP1-APn, AoA information of the UL MU-NDPs received by the initiator device AP0, or both. The location information may include the location of the initiator device AP0, the locations of one or more the responder devices AP1-APn, or any combination thereof.

As depicted in FIG. 6B, the first exchange of NDPs between the initiator device AP0 and the responder devices AP1-APn may occur during the first beacon interval 612A of the initiator device AP0. One or more additional exchanges of NDPs (or other suitable ranging frames) may occur during one or more subsequent beacon intervals. For example, as shown in FIGS. 6A and 6B, the initiator device AP0 and the responder devices AP1-APn may perform a second frame exchange 602 between times t₇ and t₁₀, which may correspond to a second beacon interval 612B of the initiator device AP0. The second frame exchange 602 may be similar to (or the same) as the first frame exchange 601). The initiator device AP0 may transmit a second beacon frame containing timestamps for the TOAs of the UL MU-NDPs and the TOD of the DL NDP associated with the second frame exchange 602 to the responder devices AP1-APn at the second TBTT, for example, as depicted in FIG. 6B.

In some other implementations, the initiator device AP0 may perform the second frame exchange 602 (or other frame exchanges) with another set of responder devices (such as APs different than AP1-APn depicted in FIGS. 6A and 6B) during the second beacon interval 612B. In this manner, the initiator device AP0 may perform ranging operations with different sets of responder devices during different beacon intervals. In some implementations, the initiator device AP0 may use different channels to perform different frame exchanges during various beacon intervals.

As a passive listening device, the STA may receive all of the frames exchanged between the initiator device AP0 and the responder devices AP1-APn. For example, the STA may receive the first UL MU-NDPs transmitted from the responder devices AP1-APn at times t_{p1,1} to t_{p1,n}, may receive the first DL NDPs transmitted from the initiator device AP0 at times tₚ₂ (denoted collectively in FIG. 5A), may receive the second UL MU-NDPs transmitted from the responder devices AP1-APn at times t_{p3,1} to t_{p3,n}, and may receive the second DL NDP transmitted from the initiator device AP0 at time tₚ₄. In some implementations, the STA may receive the first DL FB frame transmitted from the initiator device AP0 and extract timestamps for times t_{2,1} to t_{2,n} and time t₃ of the first frame exchange 601, and also may receive the second DL FB frame transmitted from the initiator device AP0 and extract timestamps for extract timestamps for times t_{2,1} to t_{2,n} and time t₃ of the second frame exchange 602. The STA may use the timestamps corresponding to different sets of times t₁-t₄ to passively determine its location based on the differences in distance between the STA and each of the access points AP0-APn.

Referring to FIG. 6C, the STA receives a first UL MU-NDP from AP1 at time t_{p1,1}, and receives a second UL MU NDP from AP2 at time t_{p1,2}. The STA receives the first DL NDP transmitted from the initiator device AP0 at time tₚ₂. The STA may use the captured timestamps t_{p1,1}, t_{p1,2}, and tₚ₂ corresponding to the reception of the first UL MU-NDP, the second UL MU-NDP, and the first DL NDP, respectively, and the timestamps for times t_{2,1} to t_{2,n} and time t₃ provided by the DL FB frame to calculate a number of differential distances between itself and the access points AP0-AP2. In some implementations, the STA may calculate the differential distance (D1) between itself and each of AP0 and AP1 using the expression:

D1=[tₚ₂−t_{p1,1}−(t₃−t_{2,1}+ToF₁)]*c,

where ToF₁ is the time-of-flight between AP0 and AP1, and c is the speed of light.

Similarly, the STA may calculate the differential distance (D2) between itself and each of AP0 and AP2 using the expression:

D2=[tₚ₂−t_{p1,2}−(t₃−t_{2,2}+ToF₂)]*c,

where ToF₂ is the time-of-flight between AP0 and AP2, and c is the speed of light. Although not shown for simplicity in FIG. 6C, the STA may calculate the differential distance between itself and AP0 and APn in a similar manner, and then use well-known hyperbolic navigation techniques to determine its location. Because the STA does not transmit any frames (but rather listens to the NDPs exchanged between the access points AP0-APn), the STA may determine its location using less power (such as compared to active ranging operations).

FIG. 7A shows a signal diagram of another example ranging operation 700, FIG. 7B shows a timing diagram 710 of the ranging operation 700 of FIG. 7A, and FIG. 7C shows a signal diagram of a passive positioning operation 720. The example ranging operation 700 may be performed using single-user (SU) frames transmitted according to the FTM protocol. For the example of FIG. 7A, each of access points AP1-APn requests the ranging operation; thus, the access points AP1-APn are the initiator devices and the access point AP0 is the responder device. Any suitable wireless device can be the initiator device, and any suitable wireless device can be the responder device.

During a discovery phase, the initiator devices AP1-APn may discover other wireless devices (such as the access point AP0) that support ranging operations. During a negotiation phase, the responder device AP0 and the initiator devices AP1-APn may exchange information and negotiate a number of ranging parameters and capabilities such as, for example, a capability of capturing timestamping, a capability of estimating angle information, a frame format to be used for exchanging ranging frames, a channel to be used for the ranging operation 700, a bandwidth with which to transmit ranging frames, a duration of the ranging operation, a periodicity of the ranging operation, the number of frame exchanges or “bursts” for each ranging operation, and so on.

The initiator devices AP1-APn may initiate the negotiation phase by transmitting FTM_REQ frames to the responder device AP0. The FTM_REQ frames may request the number of ranging parameters and capabilities. The responder device AP0 receives the FTM_REQ frames, and may acknowledge the requested ranging operation by transmitting an ACK frame to the initiator devices AP1-APn. The ACK frame may indicate the capabilities of the responder device AP0 (such as whether the responder device AP0 is capable of capturing timestamps, capable of transmitting in the requested frame format and bandwidth, and so on), and may accept a number of the ranging parameters requested by the initiator devices AP1-APn.

During a measurement phase, the initiator devices AP1-APn and the responder device AP0 may exchange a number of ranging or “measurement” frames. If both the initiator devices AP1-APn and the responder device AP0 support the FTM protocol, then the measurement phase may be performed by exchanging a number of FTM frames. For example, at time t₁, the responder device AP0 transmits an FTM_1 frame to the initiator devices AP1-APn, and may capture the TOD of the FTM_1 frame as time t₁. The initiator devices AP1-APn receive the FTM_1 frame at times t_{2,1} to t_{2,n}, and may capture the TOAs of the FTM_1 frame as times t_{2,1} to t_{2,n}, respectively. The initiator devices AP1-APn respond by transmitting ACK1 frames to the responder device AP0 at time t₃, and may capture the TOD of the ACK1 frame as time t₃. The responder device AP0 receives the ACK1 frames at times t_{4,1} to t_{4,n}, and may capture the TOAs of the ACK1 frames as times t_{4,1} to t_{4,n}, respectively. At time t₅, the responder device AP0 transmits to the initiator devices AP1-APn an FTM_2 frame that includes the timestamps captured at time t₁ and times t_{4,1} to t_{4,n} (such as the TOD of the FTM_1 frame and the TOAs of the ACK1 frames). The initiator devices AP1-APn receive the FTM_2 frame at times t_{6,1} to t_{6,n}, and may capture their timestamps as time t₆.

Upon receiving the FTM_2 frames, each of the initiator devices AP1-APn has timestamp values for times t₁, t₂, t₃, and t₄ that correspond to the TOD of the FTM_1 frame transmitted from the responder device AP0, the TOA of the FTM_1 frame received at the corresponding initiator device, the TOD of the ACK1 frame transmitted from the corresponding initiator device, and the TOA of the ACK1 frame at the initiator device AP0, respectively. Thereafter, each of the initiator devices AP1-APn may determine an RTT value as RTT=(t₄−t₃)+(t₂−t₁).

As a passive listening device, the STA may receive all of the frames exchanged between the initiator devices AP1-APn and the responder device AP0. For example, the STA may receive the FTM_1 frame transmitted from the responder device AP0 at time tₚ₁, may receive the ACK1 frames transmitted from the initiator devices AP1-APn at times t_{p2,1} to t_{p2,n}, and may receive the FTM_2 frame transmitted from the responder device AP0 at time tₚ₃, and may receive the ACK2 frames transmitted from the initiator devices AP1-APn at times t_{p4,1} to t_{p4,n}. In some implementations, the STA may receive the DL FB frame transmitted from the initiator device AP0 and extract timestamps for times t_{2,1} to t_{2,n} and time t₃ of the ranging operation 800. The STA may extract the timestamps for time t₁ and times t_{4,1} to t_{4,n} from the FTM_2 frame. The STA may use the timestamps corresponding to different sets of times t₁, times t_{2,1} to t_{2,n}, times t₃, and times t_{4,1} to t_{4,n} to passively determine its location based on the differences in distance between the STA and each of the access points AP0-APn.

In some implementations, the STA may calculate the differential distance (D1) between itself and each of AP0 and AP1 using the expression:

D1=[tₚ₁−t_{p2,1}−(t₄−t₁−ToF₁)]*c.

Similarly, the STA may calculate the differential distance (D2) between itself and each of AP0 and AP2 using the expression:

D2=[tₚ₁−t_{p2,2}−(t₄−t₁−ToF₂)]*c.

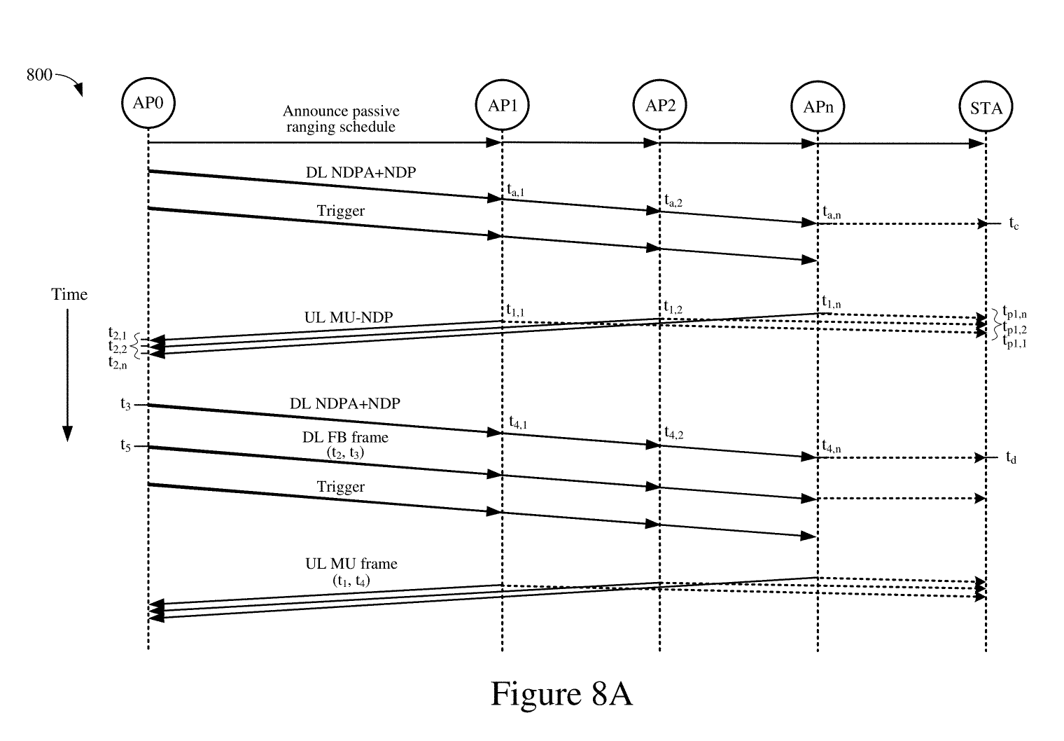

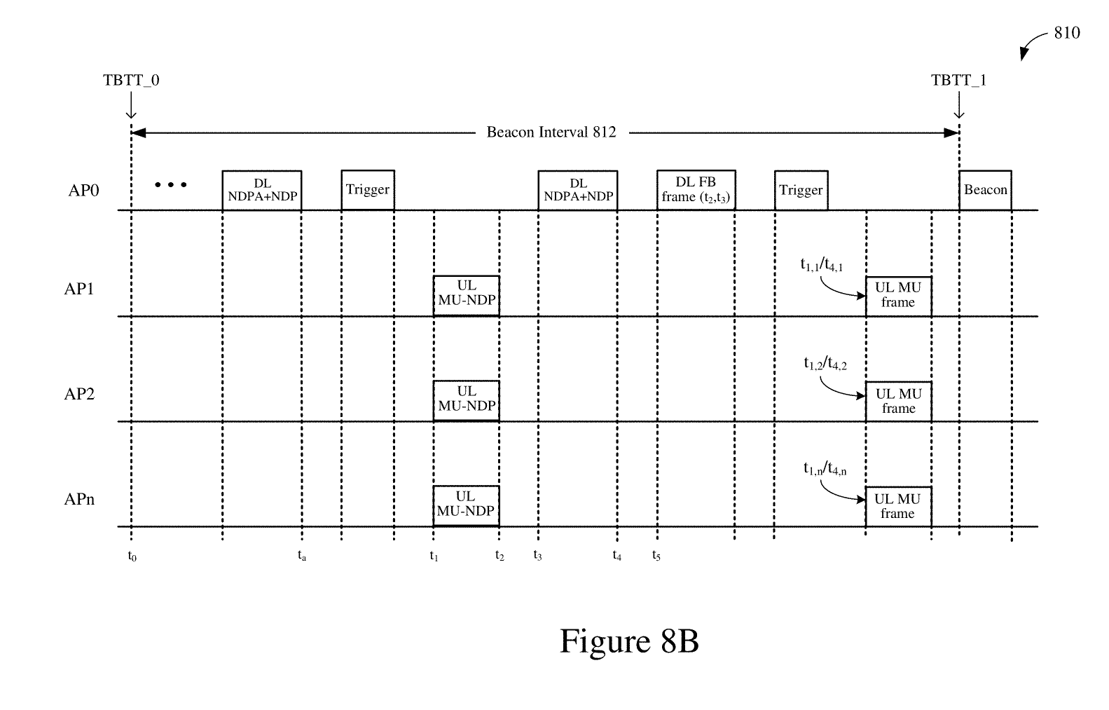

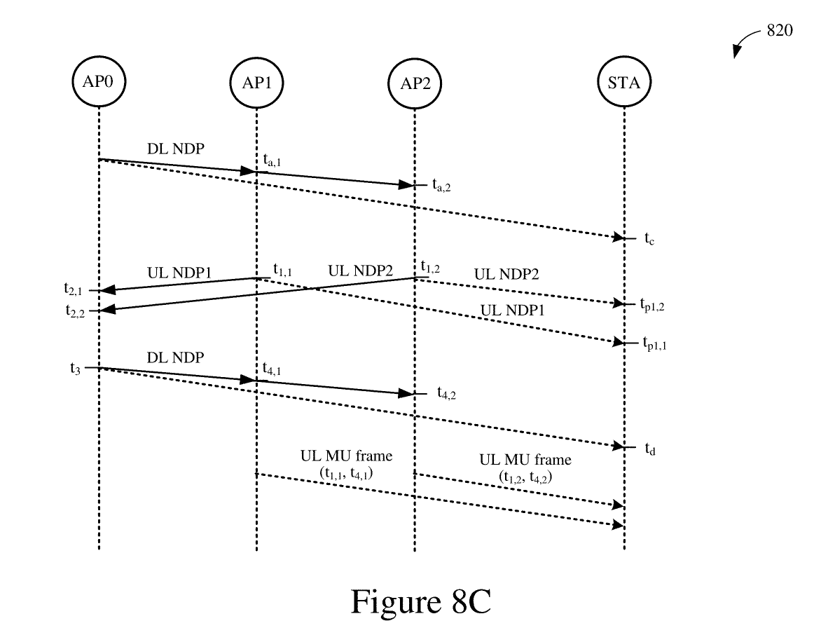

FIG. 8A shows a signal diagram of another example ranging operation 800, FIG. 8B shows a timing diagram 810 of the ranging operation 800 of FIG. 8A, and FIG. 8C shows a signal diagram of a passive positioning operation 820. The ranging operation 800 is performed between a first access point (AP0) operating as an initiator device and a number of other access points (AP1-APn) operating as responder devices. The STA may listen to the frame exchanges between the initiator device AP0 and the responder devices AP1-APn, and passively determine its location.

The access points AP0-APn of FIG. 8A may be any suitable AP including, for example, the AP 110 of FIG. 1 or the AP 200 of FIG. 2. In some other implementations, the initiator device AP0 or one or more of the responder devices AP1-APn each may be another suitable wireless device including, for example, one of the STAs 120a-120i of FIG. 1 or the STA 300 of FIG. 3. The STA may be any suitable wireless device including, for example, one of the STAs 120a-120i of FIG. 1 or the STA 300 of FIG. 3. Although only one passive listening device (such as the STA) is shown in the examples of FIGS. 8A and 8C, in some other implementations, any number of passive listening devices may listen to frames exchanged in the ranging operation 800 to passively determine their locations at the same time, or at substantially the same time.

The ranging operation 800 may be associated with or include a discovery phase and a negotiation phase similar that described above with respect to the ranging operation 500 of FIG. 5A. For example, in some implementations, the initiator device AP0 may announce the passive ranging schedule, a number of capabilities, and a number of ranging parameters in beacon frames. In some other implementations, the initiator device AP0 may announce the passive ranging schedule, a number of capabilities, and a number of ranging parameters in probe response frames.

During a measurement phase, the initiator device AP0 transmits a DL NDPA+NDP frame to the responder devices AP1-APn. Each of the responder devices AP1-APn receives the DL NDPA+NDP frame, and captures its TOA. In some implementations, the responder devices AP1-APn may capture the TOAs of the DL NDPs transmitted from the initiator device AP0 as times t_{a,1} to t_{a,n}, respectively, as depicted in FIG. 8A. For example, the first responder device AP1 may capture the TOA of the DL NDP as time t_{a,1}, the second responder device AP2 may capture the TOA of the DL NDP as time t_{a,2}, and so on, where the n^{th} responder device APn may capture the TOA of the DL NDP as time t_{a,n}.

The initiator device AP0 transmits a trigger frame to the responder devices AP1-APn. The trigger frame may inform each of the responder devices AP1-APn that the ranging operation 800 has been initiated, and may solicit each of the responder devices AP1-APn to transmit an UL MU-NDP to the initiator device AP0.

Additionally, the trigger frame may include or indicate scheduling information and grouping information for the ranging operation 800. In some implementations, the initiator device AP0 can divide the responder devices AP1-APn into a number of different groups, for example, based on available channel resources, available resources (such as the number of antennas) of the initiator device AP0, ranging parameters requested by the responder devices AP1-APn (such as the minimum number of antennas requested by each of the responder devices AP1-APn), or a combination thereof. The initiator device AP0 also may schedule different responder devices AP1-APn or different groups of responder devices AP1-APn at different times (such as in a staggered manner), and can inform the responder devices AP1-APn or groups of responder devices AP1-APn when to wake up for their scheduled ranging operation 800.

The responder devices AP1-APn receive the trigger frame, and decode the trigger frame to determine which wireless devices are identified for UL transmissions (and to determine any scheduling and grouping information that may be included in the trigger frame). At times t_{1,1} to t_{1,n}, each of respective responder devices AP1-APn transmits an UL MU-NDP to the initiator device AP0, and captures the TOD of the UL MU-NDP (as times t_{1,1} to t_{1,n}, respectively). The UL MU-NDPs may include a number of sounding sequences from which multiple RTT values may be obtained (and from which channel conditions may be estimated). The sounding sequences contained in the UL MU-NDPs may be HE-LTFs, VHT-LTFs, HT-LTFs, or legacy LTFs. The sounding sequences may be orthogonal to each other. In some implementations, the sounding sequences transmitted in the UL MU-NDPs may be selected using the P-matrix shown in FIG. 11. Additionally, each of the UL MU-NDPs transmitted from the triggered responder devices AP1-APn may include a common header.

The initiator device AP0 receives the UL MU-NDPs transmitted from responder devices AP1-APn at times t_{2,1} to t_{2,n}, respectively, and may capture the TOAs of the UL MU-NDPs (as times t_{2,1} to t_{2,n}, respectively). In some implementations, the initiator device AP0 may estimate angle information based on the sounding sequences contained in the UL MU-NDPs.

At time t₃, the initiator device AP0 transmits a DL NDPA+NDP to the responder devices AP1-APn, and may record the TOD of the DL NDPA+NDP as time t₃. The DL NDPA+NDP may include a number of sounding sequences from which multiple RTT values may be obtained (and from which channel conditions may be estimated). The sounding sequences contained in the DL NDPA+NDP may be HE-LTFs, VHT-LTFs, HT-LTFs, or legacy LTFs. The sounding sequences in the DL NDPA+NDP may be orthogonal to each other. In some implementations, the sounding sequences transmitted in the UL MU-NDPs may be selected using the P-matrix shown in FIG. 11.

The responder devices AP1-APn receive the DL NDPA+NDP at times t_{4,1} to t_{4,n}, respectively, and may capture the TOAs as times t_{4,1} to t_{4,n}, respectively. In some implementations, the responder devices AP1-APn may estimate angle information of the DL NDPA+NDP based on the sounding sequences contained therein.

At time t₅, the initiator device AP0 transmits a downlink feedback (DL FB) frame to the responder devices AP1-APn. The DL FB frame may be any suitable frame or frames including, for example, a number of single-user (SU) trigger frames, a multi-user (MU) trigger frame, a number of SU measurement feedback frames, an MU measurement feedback frame, a number of SU response frames, an MU response frame, and the like. The DL FB frame may include timestamp values for times t_{2,1} to t_{2,n} and time t₃ that correspond to the TOAs of the UL MU-NDPs received at the initiator device AP0 and the TOD of the DL NDPA+NDP transmitted from the initiator device AP0. Upon reception of the DL FB frame, each of the responder devices AP1-APn has timestamp values for t₁, t₂, t₃, and t₄, and may determine the RTT between itself and the initiator device AP0 using the expression RTT=(t₄−t₃)+(t₂−t₁). More specifically, the first responder device AP1 may determine RTT values using the expression RTT=(t_{4,1}−t₃)+(t_{2,1}−t_{1,1}), the second responder device AP2 may determine RTT values using the expression RTT=(t_{4,2}−t₃)+(t_{2,2}−t_{1,2}), and the n^{th} responder device APn may determine RTT values using the expression RTT=(t_{4,n}−t₃)+(t_{2,n}−t_{1,n}).

Although not depicted in FIG. 8A, the DL FB frame also may contain or indicate angle information and location information. The angle information may include AoD information of the UL MU-NDPs transmitted from the responder devices AP1-APn, AoA information of the UL MU-NDPs received by the initiator device AP0, or both. The location information may include the location of the initiator device AP0, the locations of one or more the responder devices AP1-APn, or any combination thereof.

The initiator device AP0 transmits another trigger frame to the responder devices AP1-APn, for example, to solicit UL transmissions from the responder devices AP1-APn identified in the trigger frame. The responder devices AP1-APn respond by transmitting UL MU frames to the initiator device AP0. The UL MU frames may be any suitable frame or frames including, for example, a number of SU measurement feedback frames, an MU measurement feedback frame, a number of SU response frames, an MU response frame, an UL MU NDP, and the like. In some implementations, the UL MU frames contains timestamps values for times t_{1,1} to t_{1,n} and times t_{a,1} to t_{a,n} from each of the responder devices AP1-APn. As depicted in FIG. 8B, the exchange of NDPs between the initiator device AP0 and the responder devices AP1-APn may occur during a beacon interval 812 of the initiator device AP0. One or more additional exchanges of NDPs (or other suitable ranging frames) may occur during one or more subsequent beacon intervals.

As a passive listening device, the STA may receive all of the frames exchanged between the initiator device AP0 and the responder devices AP1-APn. For example, the STA may receive the first DL NDP transmitted from the initiator device AP0 at time t_{c}, may receive the UL MU-NDPs transmitted from the responder devices AP1-APn at times t_{p1,1} to t_{p1,n}, and may receive the second DL NDP transmitted from the initiator device AP0 at time t_{d}. In some implementations, the STA may receive the DL FB frame transmitted from the initiator device AP0 and extract timestamps for times t_{2,1} to t_{2,n} and time t₃ of the ranging operation 800. The STA also may receive the UL MU frames transmitted from the responder devices AP1-APn and extract timestamps for times t_{1,1} to t_{1,n}, and times t_{4,1} to t_{4,n} of the ranging operation 800. The STA may use the timestamps corresponding to different sets of times t_{1,1} to t_{1,n} and times t_{4,1} to t_{4,n} to passively determine its location based on the differences in distance between the STA and each of the access points AP0-APn.

Referring to FIG. 8C, the STA receives the first DL NDP at time t_{c}, receives the first UL MU-NDP from AP1 at time t_{p1,1}, receives the second UL MU-NDP from AP2 at time t_{p1,2}, and receives the second DL NDP transmitted from the initiator device AP0 at time t_{d}. The STA may use the captured timestamps t_{c}, t_{p1,1}, t_{p1,2}, and t_{d}, the timestamps for times t_{2,1} to t_{2,n} and time t₃ provided by the DL FB frame, and the times t_{1,1} to t_{1,n} and times t_{4,1} to t_{4,n} provided in the UL MU frames to calculate a number of differential distances between itself and the access points AP0-AP2. In some implementations, the STA may calculate the differential distance (D1) between itself and each of AP0 and AP1 using the expression:

D1=[t_{d}−t_{p1,1}−(t₃−t_{2,1}+ToF₁)]*c. (Eq. 1A)

In some other implementations, the STA may calculate the differential distance D1 between itself and each of AP0 and AP1 using the expression:

D1=[t_{c}−(t_{p1,1}−t_{a,1}+ToF₁))]*c. (Eq. 1B).

The two expressions (Eq. 1A and 1B) can be added to express the differential distance as D1=[t_{d}−2*t_{p1,1}+t_{c}−(t₃−t_{2,1})+(t_{1,1}−t_{a,1})]*c/2, which does not depend on the RTT between AP0 and AP1.

Similarly, the STA may calculate the differential distance (D2) between itself and each of AP0 and AP2 using the expression:

D2=[t_{d}−t_{p1,2}−(t₃−t_{2,2}+ToF₂)]*c. (Eq. 2A)

In some other implementations, the STA may calculate the differential distance D2 between itself and each of AP0 and AP2 using the expression:

D2=[t_{c}−(t_{p1,2}−(t_{1,2}−t_{a,2}+ToF₂))]*c. (Eq. 2B).

The two expressions (Eq. 2A and Eq. 2B) can be added to express the differential distance as D2=[t_{d}−2*t_{p1,2}+t_{c}−(t₃−t_{2,2})+(t_{1,2}−t_{a,2})]*c/2, which does not depend on the RTT between AP0 and AP2.

Although not shown for simplicity in FIG. 8C, the STA may calculate the differential distance between itself and AP0 and APn in a similar manner, and then use well-known hyperbolic navigation techniques to determine its location. Because the STA does not transmit any frames (but rather listens to the NDPs exchanged between the access points AP0-APn), the STA may determine its location using less power (such as compared to active ranging operations).

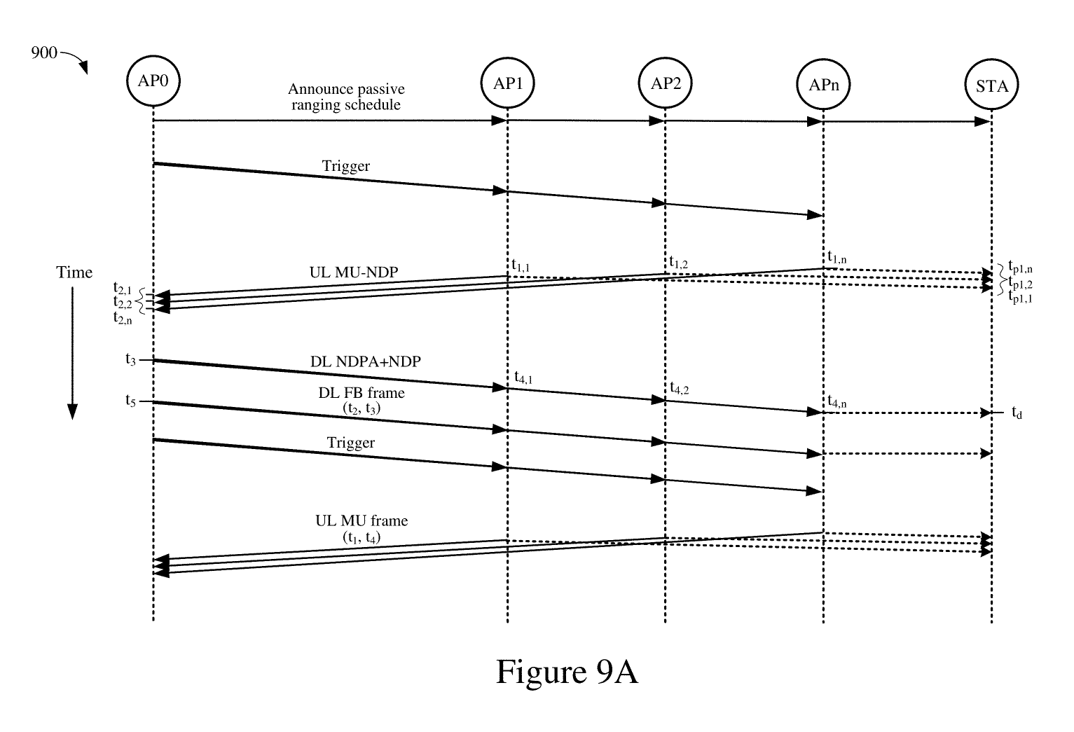

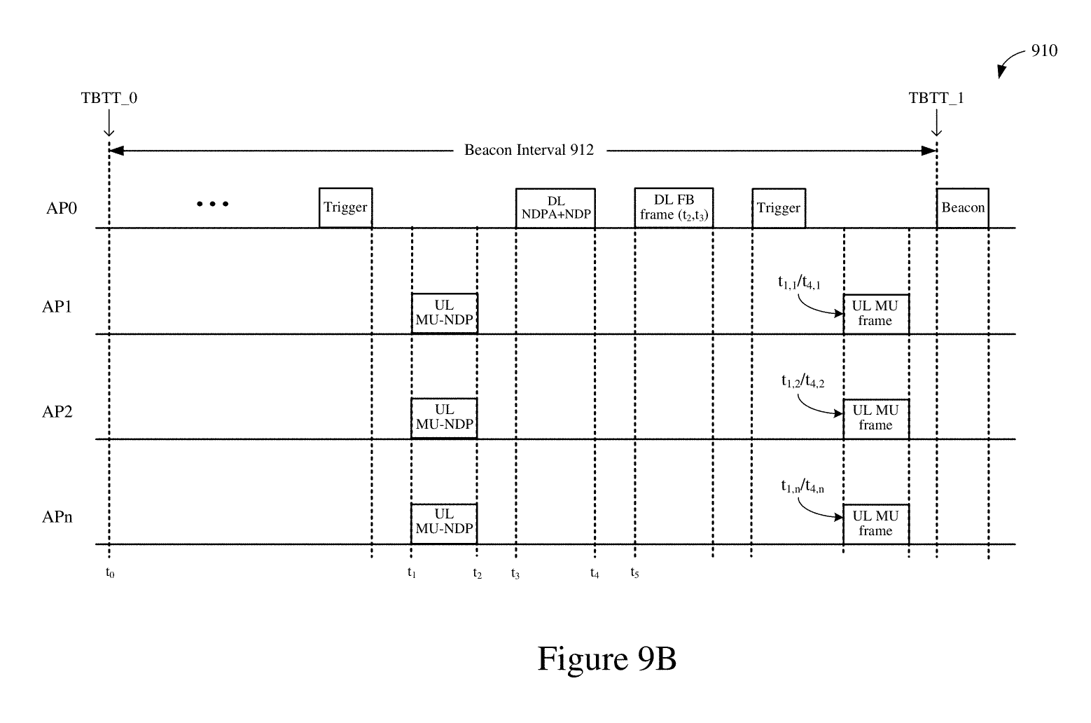

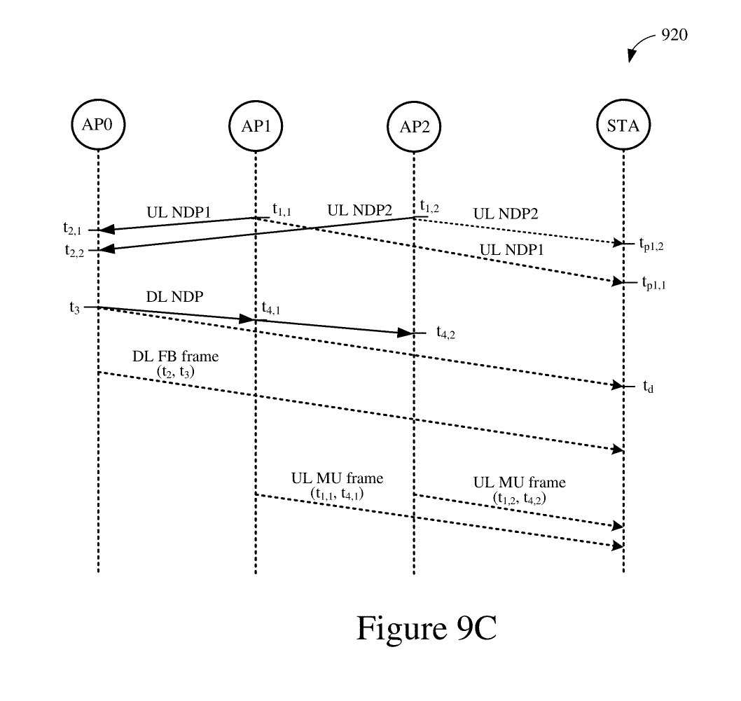

FIG. 9A shows a signal diagram of another example ranging operation 900, FIG. 9B shows a timing diagram 910 of the ranging operation 900 of FIG. 9A, and FIG. 9C shows a signal diagram of a passive positioning operation 920. The ranging operation 900 is performed between a first access point (AP0) operating as an initiator device and a number of other access points (AP1-APn) operating as responder devices. The STA may listen to the frame exchanges between the initiator device AP0 and the responder devices AP1-APn, and passively determine its location.

The access points AP0-APn of FIG. 9A may be any suitable AP including, for example, the AP 110 of FIG. 1 or the AP 200 of FIG. 2. In some other implementations, the initiator device AP0 or one or more of the responder devices AP1-APn each may be another suitable wireless device including, for example, one of the STAs 120a-120i of FIG. 1 or the STA 300 of FIG. 3. The STA may be any suitable wireless device including, for example, one of the STAs 120a-120i of FIG. 1 or the STA 300 of FIG. 3. Although only one passive listening device (such as the STA) is shown in the examples of FIGS. 9A and 9C, in some other implementations, any number of passive listening devices may listen to frames exchanged in the ranging operation 900 to passively determine their locations at the same time (or at substantially the same time). Although not shown for simplicity, in some implementations, the initiator device AP0 may feedback values for t₁ and t₄ to the other wireless devices.

The ranging operation 900 of FIGS. 9A-9C is similar to the ranging operation 800 of FIG. 8A-8C, except that transmission of the first DL NDPA+NDP is omitted from the ranging operation 900. Also, a difference as compared to the ranging scheme in FIGS. 8A-8C is that the timestamps t_{1,1} to t_{1,n} and t_{4,1} to t_{4,n} are fed back by AP1 to APn in the UL MU frames. Referring to FIG. 9C, the STA receives the first UL MU-NDP from AP1 at time t_{p1,1}, receives the second UL MU-NDP from AP2 at time t_{p1,2}, and receives the DL NDP transmitted from the initiator device AP0 at time t_{d}. The STA also may receive the UL MU frames transmitted from the responder devices AP1-APn. The STA may use the captured timestamps t_{p1,1}, t_{p1,2}, and t_{d}, the timestamps for times t_{2,1} to t_{2,n} and time t₃ provided by the DL FB frame, and the times t_{1,1} to t_{1,n} and times t_{4,1} to t_{4,n} provided in the UL MU frame to calculate a number of differential distances between itself and the access points AP0-AP2. In some implementations, the STA may calculate the differential distance (D1) between itself and each of AP0 and AP1 using the expression:

D1=[t_{d}−t_{p1,1}−(t₃−t_{2,1}+ToF₁)]*c (Eq. 1A)

Because ToF₁=((t_{4,1}−t_{3,1})+(t_{2,1}−t_{1,1}))/2, the distance D1 may be expressed as:

D1=[t_{d}−t_{p1,1}−(t₃−t_{2,1}+0.5*t_{4,1}−0.5*t_{1,1}−0.5*t₃+0.5*t_{2,1})]*c, or as:

D1=[t_{d}−t_{p1,1}−0.5*t₃+0.5*t_{2,1}−0.5*t_{4,1}+0.5*t_{1,1}]*c. (Eq. 3)

It is noted that the above expressions for determining differential distances do not depend on the ToF of signals exchanged between access points, and therefore may be insensitive to line-of-sight (LOS) signal obstructions. Additionally, any clock offsets in the clock domains of the initiator device AP0 and the responder device AP1 (or in the initiator device AP0 and another of the responder devices AP2 to APn) with respect to the clock domain of the STA cancel each other in the equation (Eq. 3), for example, because the equation (Eq. 3) contains two time stamps of opposite signs (such as positive and negative) from each clock domain.

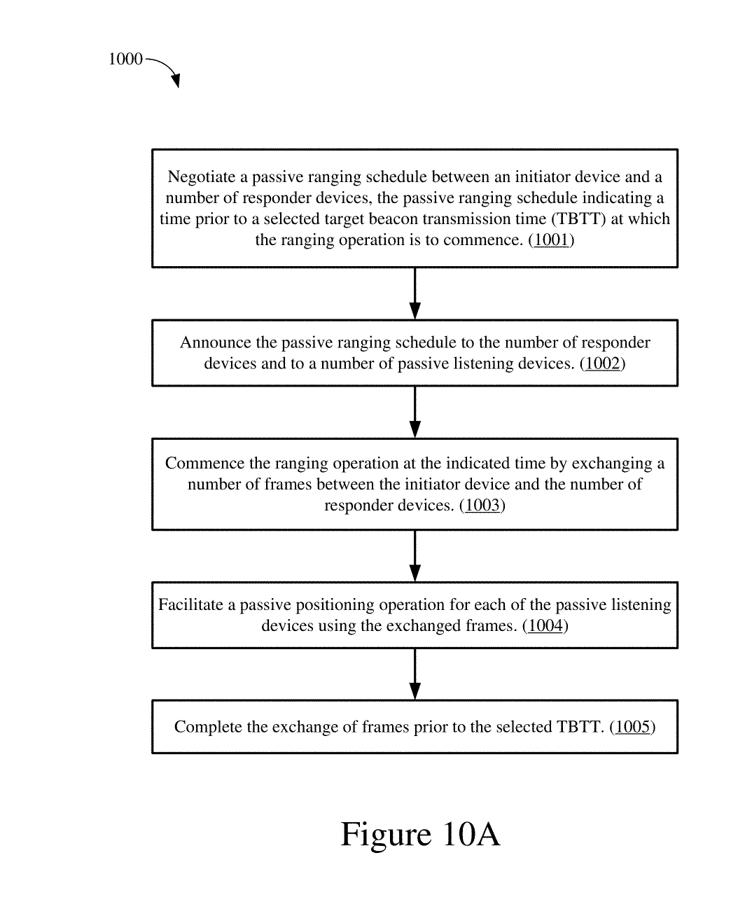

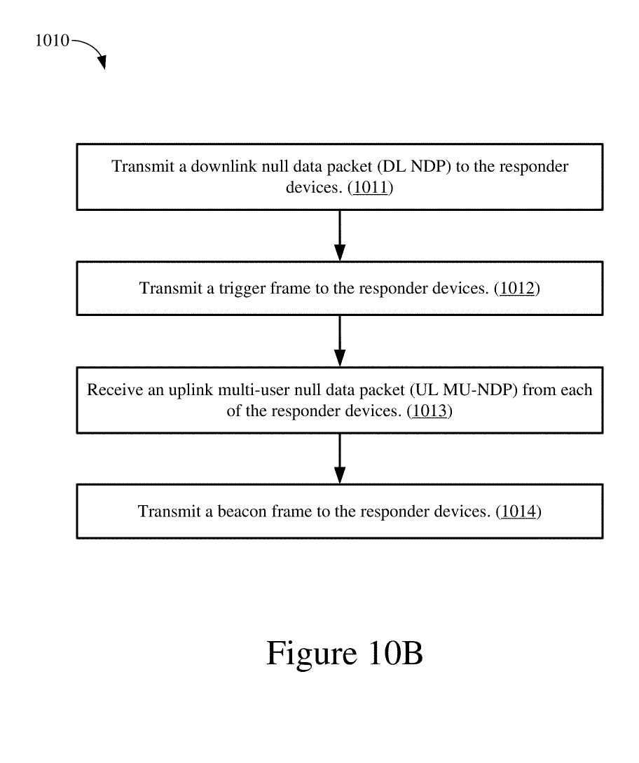

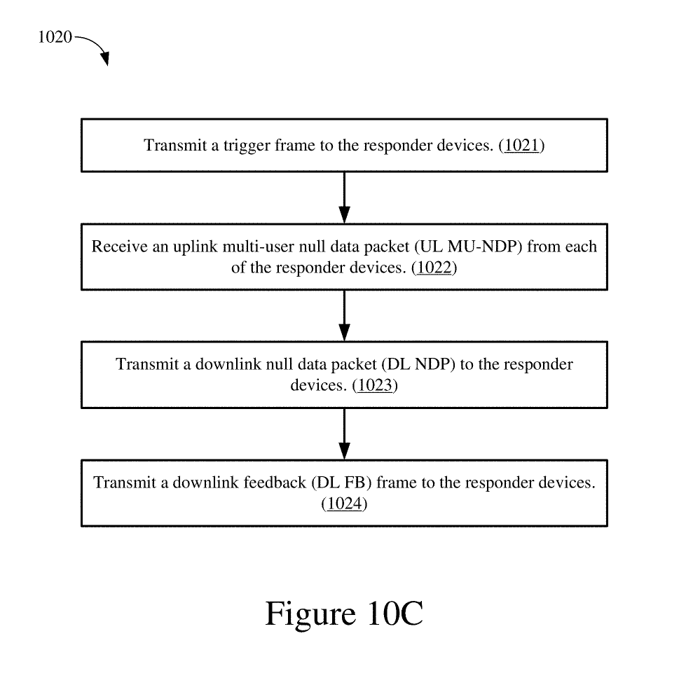

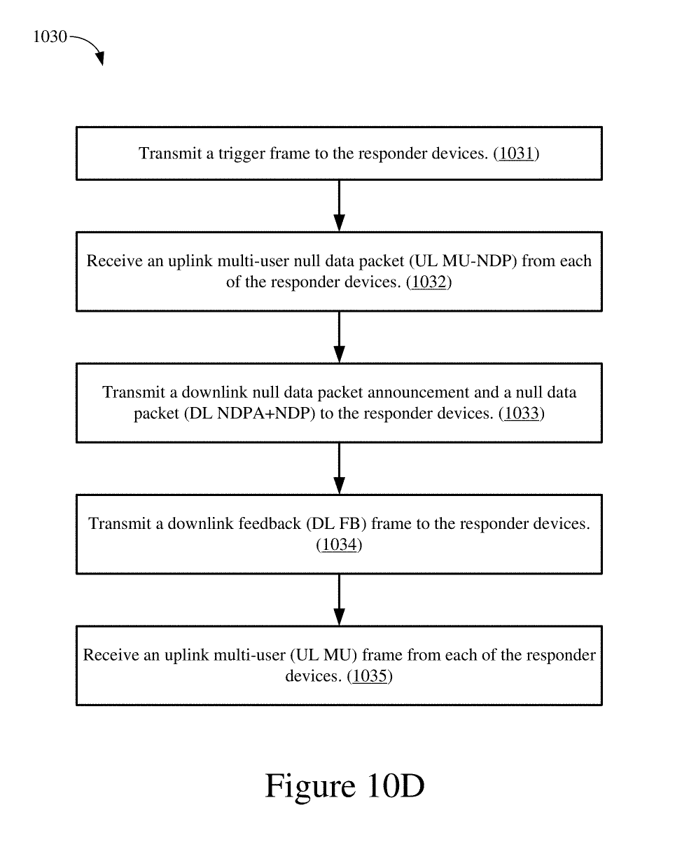

FIG. 10A shows an illustrative flow chart depicting an example ranging operation 1000. In some implementations, the example ranging operation 1000 may correspond to one or more of the example ranging operations 500, 600, 700, 800, and 900 depicted in FIGS. 5A, 6A, 7A, 8A, and 9A, respectively, such that the ranging operation 1000 is performed between the first access point (AP0) operating as an initiator device and a number of other access points (AP1-APn) operating as responder devices. A wireless device (such as the STA depicted in FIGS. 5C, 6C, 7C, 8C, and 9C) may listen to the frame exchanges between the initiator device AP0 and the responder devices AP1-APn, and passively determine its location based on the frame exchanges between the initiator device AP0 and the responder devices AP1-APn.

The initiator device may negotiate a passive ranging schedule with a number of responder devices (1001). The passive ranging schedule may indicate a time prior to a selected target beacon transmission time (TBTT) at which the ranging operation 1000 is to commence. In some implementations, the passive ranging schedule may include at least one of a participant field, a parameters field, a synchronization field, and a beacon field. The participant field may include an identity of each device participating in the ranging operation, an indication of whether each of the identified participant devices is an access point or a client device, an indication of whether each of the identified participant devices is to operate as the initiator device or as one of the responder devices, or any combination thereof. The parameters field may include a type of frames to be exchanged during the ranging operation, a number of antennas to be used by the responder devices during the ranging operation, a frequency bandwidth to be used for transmitting the frames, a wireless channel to be used for the ranging operation, a capability to capture timestamps of the frames, a capability to estimate angle information of the frames, or any combination thereof. The synchronization field may include mappings between a clock domain of the initiator device and clock domains of each of the responder devices (such as clock offset values between the clock domain of the initiator device and the clock domains of the responder devices). The beacon field may include the TBTTs of each of the responder devices.

The initiator device may announce the passive ranging schedule to the number of responder devices and to a number of passive listening devices (1002). In some implementations, the initiator device may announce the passive ranging schedule using beacon frames. In some other implementations, the initiator device may announce the passive ranging schedule using probe response frames. In addition, or in the alternative, the initiator device may broadcast the passive ranging schedule in every N^{th} beacon frame (such that N is an integer greater than one), where each beacon frame includes a counter value indicating which of the beacon frames includes the passive ranging schedule. In some implementations, each beacon frame may include a “NeighborReport Count” (NC) field that stores a counter value indicating whether the beacon frame contains the passive ranging schedule. For example, when the passive ranging schedule is contained in every N^{th} beacon frame, the initiator device AP0 may set the counter value to an initial value of N, and decrement the counter value (by one) upon transmission of each beacon frame such that a beacon frame having a counter value of zero stored in its NC field is the beacon frame that includes the passive ranging schedule. In some other implementations, each of the responder devices AP1-APn and passive listening devices may include a local counter that is initialized to a value of N, and decrement its local counter (by one) each time a beacon frame is transmitted from the initiator device AP0.

The initiator device may commence the ranging operation at the indicated time by exchanging a number of frames between the initiator device and the number of responder devices (1003). In some implementations, the initiator device and the number of responder devices may exchange frames according to a fine timing measurement (FTM) protocol, and the exchanged frames may include a number of multi-user null data packets (MU-NDPs). In some implementations, each of the MU-NDPs may include a number of sounding sequences from which multiple round trip time (RTT) values may be obtained. In addition, or in the alternative, the sounding sequences contained in the MU-NDPs may be used to estimate angle information of the MU-NDPs.

The initiator device may facilitate a passive positioning operation for each of the passive listening devices using the exchanged frames (1004). A passive listening device (such as the STA 300 of FIG. 3) may receive and capture timestamps of the frames exchanged between the initiator device and the responder devices, and also may receive additional timing information relating to the exchanged frames from the initiator device, from the responder devices, or both. In some implementations, the initiator device may embed the timing information into one or more frames transmitted to the responder devices (and received by the passive listening device). The passive listening device may use the captured timestamps and the received timing information to determine a differential distance between itself and each of the initiator device and a corresponding responder device, for example, as described with respect to FIGS. 5C, 6C, 7C, 8C, and 9C.

The initiator device may complete the exchange of frames prior to the selected TBTT (1005). By completing frame exchanges prior to the transmission of the next beacon frame (such as prior to the selected TBTT), frame exchanges associated with the ranging operation 1000 may not interfere with beacon frame transmissions. Additionally, by completing frame exchanges prior to the selected TBTT, timing information may be included in the next beacon frame. In some implementations, the initiator device may be given final authority over one or more parameters of the ranging operation, for example, so that an access point operating as the initiator device may perform the ranging operations on its own channel.

FIG. 10B shows an illustrative flow chart depicting an example frame exchange 1010. In some implementations, the example frame exchange 1010 may be performed between the initiator device AP0 and the responder devices AP1-APn depicted in FIG. 5A. A passive listening device (such as the STA 300 of FIG. 3) may listen to the frame exchanges between the initiator device and the responder devices, and passively determine its location based on the frame exchanges.

The initiator device may transmit a downlink null data packet (DL NDP) to the responder devices (1011). The DL NDP may include a plurality of sounding sequences from which a corresponding plurality of RTT values may be obtained (and from which channel conditions may be estimated). The responder devices may use the sounding sequences to estimate angle information of the DL NDP. The sounding sequences contained in the DL NDP may be HE-LTFs, VHT-LTFs, HT-LTFs, or legacy LTFs, and may be orthogonal to each other. In some implementations, the sounding sequences transmitted in the DL NDP may be selected using the P-matrix shown in FIG. 11. Each of the responder devices may capture the TOA of the DL NDP, and the initiator device may capture the TOD of the DL NDP.

In some implementations, the DL NDP also may include a null data packet announcement (NDPA) that announces the DL NDP. In some other implementations, the initiator device may transmit a separate DL NDPA to the responder devices (such as a SIFS duration before transmitting the DL NDP to the responder devices).

The initiator device may transmit a trigger frame to the responder devices (1012). The trigger frame may inform each of the responder devices that a ranging operation has been initiated, and may solicit each of the responder devices to transmit an uplink multi-user null data packet (UL MU-NDP) to the initiator device. In some implementations, the trigger frame may include or indicate scheduling information and grouping information for the ranging operation.

The initiator device may receive an UL MU-NDP from each of the responder devices (1013). The UL MU-NDPs may include a plurality of sounding sequences from which a corresponding plurality of RTT values may be obtained (and from which channel conditions may be estimated by the initiator device). The initiator device also may use the sounding sequences to estimate angle information of the UL MU-NDPs. The sounding sequences contained in the UL MU-NDPs may be HE-LTFs, VHT-LTFs, HT-LTFs, or legacy LTFs, and may be orthogonal to each other. In some implementations, the sounding sequences transmitted in the UL MU-NDPs may be selected using the P-matrix shown in FIG. 11. Each of the responder devices may capture the TOD of a corresponding one of the UL MU-NDPs, and the initiator device may capture the TOAs of each of the UL MU-NDPs.

The initiator device may transmit, to the responder devices, a beacon frame (1014). The beacon frame may include timing information indicating time of arrival (TOA) values of the UL MU-NDPs received at the initiator device and indicating a time of departure (TOD) value of the DL NDP transmitted from the initiator device. Each of the responder devices AP1-APn may use the received timing information, along with their determined TOA values for the DL NDP and their determined TOD value for the UL MU-NDP, to determine one or more RTT values between itself and the initiator device (such as described with respect to FIG. 5A).

FIG. 10C shows an illustrative flow chart depicting an example frame exchange 1020. In some implementations, the example frame exchange 1020 may be performed between the initiator device AP0 and the responder devices AP1-APn depicted in FIG. 6A. A passive listening device (such as the STA 300 of FIG. 3) may listen to the frame exchanges between the initiator device and the responder devices, and passively determine its location based on the frame exchanges.

The initiator device may transmit a trigger frame to the responder devices (1021). The trigger frame may inform each of the responder devices that a ranging operation has been initiated, and may solicit each of the responder devices to transmit an uplink multi-user null data packet (UL MU-NDP) to the initiator device. In some implementations, the trigger frame may serve as an implicit NDPA for the DL NDP to be transmitted from the initiator device, thereby eliminating the need to transmit a separate NDPA to the responder devices. In addition, or in the alternative, the trigger frame may include or indicate scheduling information and grouping information for the ranging operation.

The initiator device may receive an UL MU-NDP from each of the responder devices identified by the trigger frame (1022). The UL MU-NDPs may include a plurality of sounding sequences from which a corresponding plurality of RTT values may be obtained (and from which channel conditions may be estimated by the initiator device). The initiator device also may use the sounding sequences to estimate angle information of the UL MU-NDPs. The sounding sequences contained in the UL MU-NDPs may be HE-LTFs, VHT-LTFs, HT-LTFs, or legacy LTFs, and may be orthogonal to each other. In some implementations, the sounding sequences transmitted in the UL MU-NDPs may be selected using the P-matrix shown in FIG. 11. Each of the responder devices may capture the TOD of a corresponding one of the UL MU-NDPs, and the initiator device may capture the TOAs of each of the UL MU-NDPs.

The initiator device may transmit a downlink null data packet (DL NDP) to the responder devices (1023). The DL NDP may include a plurality of sounding sequences from which a corresponding plurality of RTT values may be obtained (and from which channel conditions may be estimated). The responder devices may use the sounding sequences to estimate angle information of the DL NDP. The sounding sequences contained in the DL NDP may be HE-LTFs, VHT-LTFs, HT-LTFs, or legacy LTFs, and may be orthogonal to each other. In some implementations, the sounding sequences transmitted in the UL MU-NDPs may be selected using the P-matrix shown in FIG. 11. Each of the responder devices may capture the TOA of the DL NDP, and the initiator device may capture the TOD of the DL NDP.

The initiator device may transmit a downlink feedback (DL FB) frame to the responder devices (1024). The DL FB frame may include timing information indicating the TOAs of the UL MU-NDPs received at the initiator device and indicating the TOD of the DL NDP transmitted from the initiator device. The DL FB frame may be any suitable frame or frames including, for example, a number of single-user (SU) trigger frames, a multi-user (MU) trigger frame, a number of SU measurement feedback frames, an MU measurement feedback frame, a number of SU response frames, an MU response frame, and the like. Each of the responder devices may use the received timing information, along with their captured timestamps, to determine one or more RTT values between itself and the initiator device (such as described with respect to FIG. 6A). In addition, or in the alternative, the DL FB frame may include at least one of angle of departure (AoD) information of the UL MU-NDPs transmitted from the responder devices, location information of the initiator device, and location information of one or more of the responder devices.

FIG. 10D shows an illustrative flow chart depicting another example frame exchange 1030. In some implementations, the example frame exchange 1030 may be performed between the initiator device AP0 and the responder devices AP1-APn depicted in FIG. 8A. A passive listening device (such as the STA 300 of FIG. 3) may listen to the frame exchanges between the initiator device and the responder devices, and passively determine its location based on the frame exchanges.

The initiator device may transmit a trigger frame to the responder devices (1031). The trigger frame may inform each of the responder devices that a ranging operation has been initiated, and may solicit each of the responder devices to transmit an uplink multi-user null data packet (UL MU-NDP) to the initiator device. In some implementations, the trigger frame may include or indicate scheduling information and grouping information for the ranging operation.

The initiator device may receive an UL MU-NDP from each of the responder devices (1032). The UL MU-NDPs may include a plurality of sounding sequences from which a corresponding plurality of RTT values may be obtained (and from which channel conditions may be estimated by the initiator device). The initiator device also may use the sounding sequences to estimate angle information of the UL MU-NDPs. The sounding sequences contained in the UL MU-NDPs may be HE-LTFs, VHT-LTFs, HT-LTFs, or legacy LTFs, and may be orthogonal to each other. In some implementations, the sounding sequences transmitted in the UL MU-NDPs may be selected using the P-matrix shown in FIG. 11. Each of the responder devices may capture the TOD of a corresponding one of the UL MU-NDPs, and the initiator device may capture the TOAs of each of the UL MU-NDPs.

The initiator device may transmit a downlink null data packet announcement and a null data packet (DL NDPA+NDP) to the responder devices (1033). The DL NDPA+NDP may include a plurality of sounding sequences from which a corresponding plurality of RTT values may be obtained (and from which channel conditions may be estimated by the responder devices). The responder devices also may use the sounding sequences to estimate angle information of the DL NDPA+NDP. The sounding sequences contained in the DL NDPA+NDP may be HE-LTFs, VHT-LTFs, HT-LTFs, or legacy LTFs, and may be orthogonal to each other. Each of the responder devices may capture the TOA of the DL NDPA+NDP, and the initiator device may capture the TOD of the DL NDPA+NDP. In some other implementations, the initiator device may separately transmit the DL NDPA and the DL NDP to the responder devices (such as rather than transmitting the NDPA and the NDP in the same MU frame).

The initiator device may transmit a downlink feedback (DL FB) frame to the responder devices (1034). The DL FB frame may be any suitable frame or frames including, for example, a number of single-user (SU) trigger frames, a multi-user (MU) trigger frame, a number of SU measurement feedback frames, an MU measurement feedback frame, a number of SU response frames, an MU response frame, and the like. The DL FB frame may include timing information indicating the TOAs of the UL MU-NDPs received at the initiator device and indicating the TOD of the DL NDPA+NDP transmitted from the initiator device. Each of the responder devices may use the received timing information, along with their captured timestamps, to determine one or more RTT values between itself and the initiator device (such as described with respect to FIG. 8A). In addition, or in the alternative, the DL FB frame may include at least one of angle of departure (AoD) information of the UL MU-NDPs transmitted from the responder devices, location information of the initiator device, and location information of one or more of the responder devices.

The initiator device may receive an UL MU frame from each of the responder devices (1035). The UL MU frames may be any suitable frame or frames including, for example, a number of SU measurement feedback frames, an MU measurement feedback frame, a number of SU response frames, an MU response frame, an UL MU NDP, and the like. In some implementations, the UL MU frame may include timing information indicating the TOD values of the UL MU-NDPs transmitted from the responder devices and indicating the TOA values of the DL NDPA+NDP arriving at the responder devices. The initiator device may use the received timing information, along with its determined TOA values of the UL MU-NDPs and its determined TOD of the DL NDPA+NDP, to determine one or more RTT values between itself and each of the responder devices (such as described with respect to FIG. 8A).

FIG. 11 shows an example table 1100 indicating the number and orthogonality of sounding sequences that may be included within (or appended to) the frames exchanged during one or more of the example ranging operations 500, 600, 700, 800, and 900 described with respect to FIGS. 5A-5E, 6A-6C, 7A-7C, 8A-8C, and 9A-9C. In some implementations, the example table 1100 of FIG. 11 may correspond to the LTF-mapping matrix specified by the IEEE 802.11ax standards, and also may be used to orthogonalize sounding sequences received from different antennas of a transmitting device. A transmitting device may use the table 1100 to select the sounding sequences to be transmitted to a receiving device (such as during ranging operations), and the receiving device may use the table 1100 to orthogonalize or decode sounding sequences received from the transmitting device. In some implementations, the transmitting device and the receiving device may store the table 1100 in a suitable memory (such as in the memory 230 of the AP 200 of FIG. 2 or the memory 330 of the STA 300 of FIG. 3). Although the sounding sequences in the example table 1100 are depicted as sounding LTFs, other suitable sounding sequences may be used.

The example table 1100 is depicted in FIG. 11 as including thirteen patterns (P1-P13) that may be used by a receiving device to estimate angle information during ranging operations. Each of the 13 patterns P1-P13 may include one or more of four sounding sequences LTF1, LTF2, LTF3, and LTF4 or rotated versions thereof. As used herein, a rotated version of a sounding LTF may be generated using sign inversion, for example, so that the original sounding LTF and the rotated sounding LTF are orthogonal to each other. For example, a rotated version of LTF1 may be denoted as −LTF1, a rotated version of LTF2 may be denoted as −LTF2, a rotated version of LTF3 may be denoted as −LTF3, and a rotated version of LTF4 may be denoted as −LTF4. In addition, each of the sounding sequences LTF1, LTF2, LTF3, and LTF4 may refer or correspond to a four (4) μs slot in an HE packet extension or an NDP. The use of orthogonal sounding LTFs in HE packet extensions or in NDPs may allow a receiving device to distinguish between sounding LTFs transmitted in different spatial streams (such as by different antennas of the transmitting device).

The sounding sequences transmitted by multiple antennas may be separated by code (such as using the P-matrix) and separated in time (such as using cyclic shift diversity (CSD) values). Additional dimensions may be incorporated into the sounding sequences by leveraging CSD values for shorter PE or NDP durations. For example, an 8 μs packet extension including 2 LTF symbols may be used to sound 4 antennas. The 4 antennas may be grouped into 2 antenna pairs such that each pair of antennas corresponds with a respective row of a 2-row P-matrix, and the antennas within each pair are further separated by an appropriate CSD value.

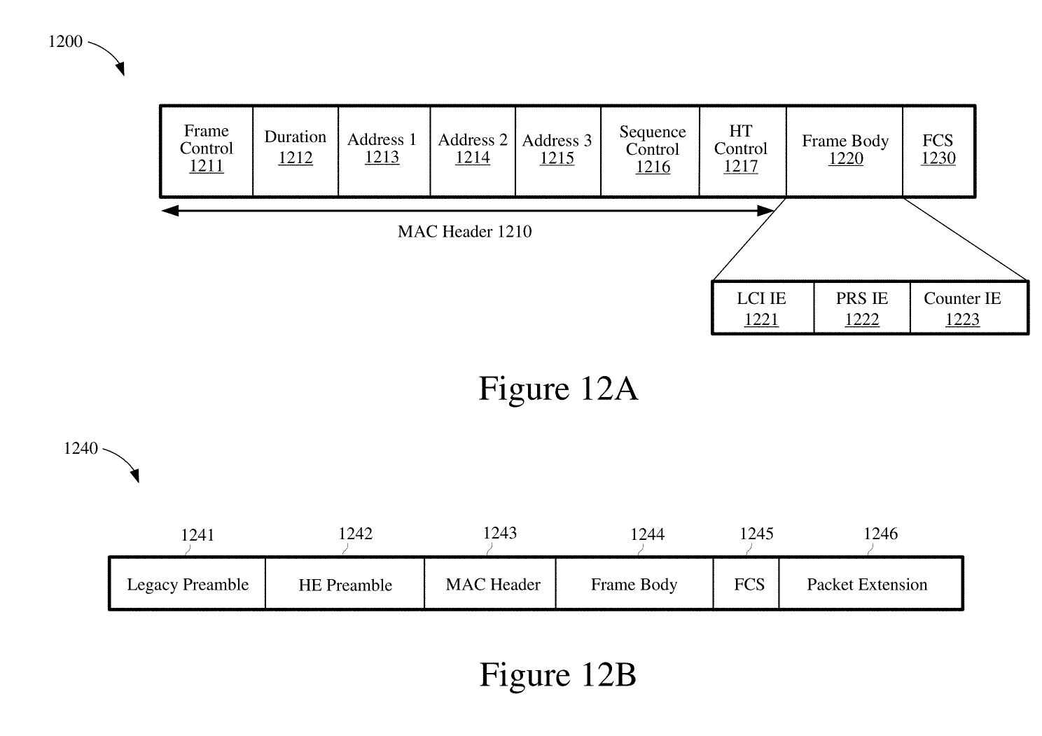

FIG. 12A shows an example management frame 1200. In some implementations, the management frame 1200 may be used form the beacon frames shown in the ranging operations 500, 600, 700, 800, and 900 described with respect to FIGS. 5A-5E, 6A-6C, 7A-7C, 8A-8C, 9A-9C, respectively. In some other implementations, the management frame 1200 may be used form probe responses that contain passive ranging schedules in accordance with various aspects of the present disclosure. The management frame 1200 is shown to include a MAC header 1210, a frame body 1220, and a frame check sequence (FCS) field 1230. The MAC header 1210 may include a frame control field 1211, a duration field 1212, an address 1 field 1213, an address 2 field 1214, an address 3 field 1215, a sequence control field 1216, and a high-throughput (HT) control field 1217. Although not shown for simplicity, the frame control field 1211 may include a Type field to store a value indicating whether the frame 1200 is a control frame, a data frame, or a management frame, and may include a Sub-type field to store a value indicating a type of control frame, data frame, or management frame.

The duration field 1212 may store the value of the Network Allocation Vector (NAV). The address 1 field 1213 may store the MAC address of the receiving device, the address 2 field 1214 may store the MAC address of the transmitting device, and the address 3 field 1215 may be used for filtering (such as by an AP). The sequence control field 1216 may store sequence information (such as used for data re-transmissions). The HT control field 1217 may store information for high-throughput packets. In some implementations, when the management frame 1200 is to be used as a beacon frame, the “address 1” field 1213 may store a broadcast address value, the “address 2” field 1214 may contain the MAC address of the broadcasting AP, and the “address 3” field 1215 may contain the BSSID of the corresponding WLAN.

The frame body 1220 is shown to include an LCI information element (IE) 1221, a passive ranging schedule (PRS) IE 1222, and a counter IE 1223. Although only one LCI IE 1221 is shown in FIG. 12A, it is to be understood that the management frame 1200 may include any suitable number of LCI IEs 1221. Similarly, although only one PRS IE 1222 is shown in FIG. 12A, it is to be understood that the management frame 1200 may include any suitable number of PRS IEs 1222.

The LCI IE 1221 may include LCI values for any suitable number of wireless devices. In some implementations, the LCI IE 1221 may include the LCI value of the initiator device. In some other implementations, the LCI IE 1221 may include the LCI values of both the initiator device and the responder devices of a specified passive ranging operation. In still other implementations, the LCI IE 1221 may include the LCI values of any number of wireless devices associated with scheduled passive ranging operations.

The PRS IE 1222 may include the passive ranging schedule of the initiator device. More specifically, the passive ranging schedule may indicate specific times and/or specific wireless channels on which the initiator device is to perform a ranging operation with a number of other wireless devices. The passive ranging schedule may indicate any number of scheduled ranging operations with any number of other wireless devices.

The counter IE 1223 may store a counter value indicating an index of the corresponding beacon frame. In some implementations, the counter value stored in the counter IE 1223 may be used by a receiving device to synchronize its local counter value and/or to determine when the next beacon frame containing a PRS and/or LCI values is to be transmitted from the initiator device. For other implementations, the counter IE 1223 may be omitted, and the counter value may be stored in any suitable field of the management frame 1200.

In some implementations, a device that receives a beacon frame transmitted from the initiator device may extract the counter value (V_{BF}) contained in the beacon frame, and may use the counter value (V_{BF}) to determine the index of the beacon frame. The receiving device (such as a responder device or a passive listening device) may use the extracted count value V_{BF} and the value of N to identify the next beacon frame that will contain the PRS and/or the LCI values.

The receiving device also may use the count value V_{BF} extracted from the beacon frame to synchronize its local counter with the count value V_{BF} or index of the beacon frame. For example, if the receiving device receives a beacon frame from the initiator device containing an index of 30 (such as a counter value V_{BF}=30), then the receiving device may set its local counter value equal to the index of the received beacon frame (such as V_{local}=V_{BF}=30). The receiving device may decrement the local counter value each time a beacon frame is transmitted from the initiator device. When the local counter value V_{local}=1, which may indicate that the next beacon frame will contain the PRS and one or more LCI values, the receiving device may prepare to receive the PRS and one or more LCI values, for example, by ensuring that the device is in an awake state at time t_{AP1,N} to receive the N^{th} beacon frame. Then, at time t_{AP1,N}, the receiving device receives the N^{th} beacon frame containing the PRS and one or more LCI values, and may decrement the local counter value V_{local}=0.

The responder devices each may store beacon index information indicating the periodicity with which the PRS and LCI values are inserted into beacon frames. In some implementations, the stored beacon index information may be the initial value of V_{BF}. For one example, each of the responder devices may initialize its local counter value to the number N when every N^{th} beacon frame is to contain the PRS and LCI values, as described above. For another example, each of the responder devices may maintain its local counter value as zero when every beacon frame is to include the PRS and LCI values.

FIG. 12B shows an example high efficiency (HE) packet 1240. The HE packet 1240 may be used to transmit one or more of the frames exchanged during the ranging operations 500, 600, 700, 800, and 900 described above. The HE packet 1240 is shown to include a legacy preamble 1241, a HE preamble 1242, a MAC header 1243, a frame body 1244, a frame check sequence (FCS) field 1245, and a packet extension 1246. The legacy preamble 1241 may include synchronization information, timing information, frequency offset correction information, and signaling information. The HE preamble 1242 also may include synchronization information, timing information, frequency offset correction information, and signaling information.

The MAC header 1243 may contain information describing characteristics or attributes of data encapsulated within the frame body 1244, may include a number of fields indicating source and destination addresses of the data encapsulated within the frame body 1244, and may include a number of fields containing control information. More specifically, although not shown in FIG. 12B for simplicity, the MAC header 1243 may include, for example, a frame control field, a duration field, a destination address field, a source address field, a BSSID field, and a sequence control field.

The frame body 1244 may store data including, for example, one or more information elements (IEs) that may be specific to the frame type indicated in the MAC header 1243. The FCS field 1245 may include information used for error detection and data recovery.

The packet extension 1246 does not typically store any data, but rather stores “dummy” data or padding, for example, to allow a receiving device more time to decode HE packet 1240 without giving up medium access. In some implementations, the packet extension 1246 may be used to store LCI values of one or more wireless devices (such as APs and STAs). In some other implementations, the packet extension 1246 may store a number of sounding sequences that may be used by a receiving device to obtain RTT values, to estimate channel conditions, and to estimate angle information of the HE packet 1240.

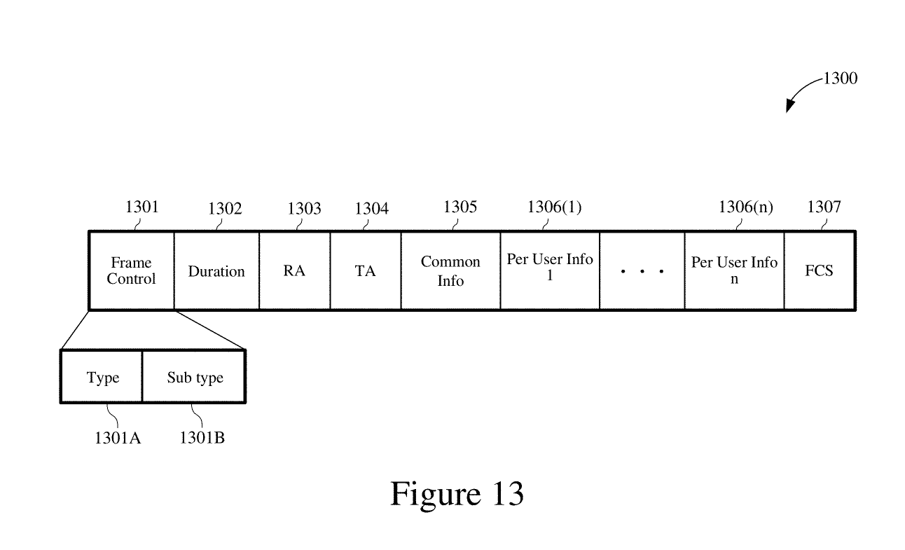

FIG. 13 shows an example trigger frame 1300. The trigger frame 1300 is shown to include a frame control field 1301, a duration field 1302, a receiver address (RA) field 1303, a transmitter address (TA) field 1304, a Common Info field 1305, a number of Per User Info fields 1306(1)-1306(n), and a frame check sequence (FCS) field 1307.

The frame control field 1301 includes a Type field 1301A and a Sub-type field 1301B. The Type field 1301A may store a value to indicate that frame 1300 is a control frame, and the Sub-type field 1301B may store a value indicating a trigger frame. The duration field 1302 may store information indicating a duration or length of the trigger frame 1300. The RA field 1303 may store the address of a receiving device (such as one of the responder devices AP1-APn of FIG. 5A, 6A, 7A, 8A, or 9A). The TA field 1304 may store the address of a transmitting device (such as the initiator device AP0 of FIG. 5A, 6A, 7A, 8A, or 9A). The Common Info field 1035 may store information common to one or more receiving devices. Each of the Per User Info fields 1306(1)-1306(n) may store information for a particular receiving device. The FCS field 1307 may store a frame check sequence (such as for error detection).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of performing a ranging operation, comprising:
negotiating a passive ranging schedule between an initiator device and a number of responder devices, the passive ranging schedule indicating a time prior to a selected target beacon transmission time (TBTT) at which the ranging operation is to commence;
announcing the passive ranging schedule to the number of responder devices and to a number of passive listening devices;
commencing the ranging operation at the indicated time by exchanging a number of frames between the initiator device and the number of responder devices;
facilitating a passive positioning operation for each of the passive listening devices using the exchanged frames; and
completing the exchange of frames prior to the selected TBTT.

2. The method of claim 1, wherein the passive ranging schedule comprises a participant field including at least one of an identity of each device participating in the ranging operation, an indication of whether each of the identified participant devices is an access point or a client device, and an indication of whether each of the identified participant devices is to operate as the initiator device or as one of the responder devices.

3. The method of claim 1, wherein the passive ranging schedule comprises a parameters field including at least one of a type of frames to be exchanged during the ranging operation, a number of antennas to be used by the responder devices during the ranging operation, a frequency bandwidth to be used for transmitting the frames, a wireless channel to be used for the ranging operation, a capability to capture timestamps of the frames, and a capability to estimate angle information of the frames.

4. The method of claim 1, wherein the passive ranging schedule comprises a synchronization field including mappings between a clock domain of the initiator device and clock domains of each of the responder devices, wherein the mappings comprise at least clock offset values between the clock domain of the initiator device and the clock domains of the responder devices.

5. The method of claim 1, wherein the announcing comprises:
broadcasting the passive ranging schedule in every N^{th} beacon frame, wherein each beacon frame includes a counter value indicating which of the beacon frames includes the passive ranging schedule, and wherein N is an integer greater than one.

6. The method of claim 1, wherein the frames are exchanged according to a fine timing measurement (FTM) protocol and comprise a number of multi-user null data packets (MU-NDPs), and at least one of the MU-NDPs comprises an uplink (UL) MU-NDP transmitted from multiple antennas of a respective one of the responder devices.

7. The method of claim 1, wherein exchanging the number of frames comprises:
transmitting, to the responder devices, a downlink null data packet (DL NDP) including a plurality of sounding sequences from which a corresponding plurality of round trip time (RTT) values are obtained;
transmitting a trigger frame to the responder devices;
receiving an uplink multi-user null data packet (UL MU-NDP) from each of the responder devices identified by the trigger frame; and
transmitting, to the responder devices, a beacon frame including timing information indicating time of arrival (TOA) values of the UL MU-NDPs received at the initiator device and indicating a time of departure (TOD) value of the DL NDP transmitted from the initiator device.

8. The method of claim 1, wherein exchanging the number of frames comprises:
transmitting a trigger frame to the responder devices;
receiving an uplink multi-user null data packet (UL MU-NDP) from each of the responder devices identified by the trigger frame;
transmitting a downlink null data packet (DL NDP) to the responder devices; and
transmitting, to the responder devices, a downlink feedback (DL FB) frame including timing information indicating time of arrival (TOA) values of the UL MU-NDPs received at the initiator device and indicating a time of departure (TOD) value of the DL NDP transmitted from the initiator device.

9. The method of claim 8, wherein the DL FB frame further includes at least one of angle of departure (AoD) information of the UL MU-NDPs transmitted from the responder devices, location information of the initiator device, and location information of one or more of the responder devices.

10. The method of claim 8, wherein the DL NDP further comprises a null data packet announcement (NDPA).

11. The method of claim 8, wherein exchanging the number of frames further comprises:
receiving, from each of the responder devices, an uplink multi-user (UL MU) frame including timing information indicating TOD values of the UL MU-NDPs transmitted from the responder devices and indicating TOA values of the DL NDP arriving at the responder devices.

12. The method of claim 11, wherein facilitating the passive positioning operation comprises:
enabling the passive listening device to determine a differential distance between itself and each of a pair of the initiator device and one of the responder devices based on the timing information included in the DL FB frame, the timing information included in the UL MU frames transmitted from the pair of the responder devices, and TOA values of the UL MU-NDPs at the passive listening device.

13. An apparatus for performing a ranging operation, comprising:
one or more transceivers configured to exchange wireless signals with one or more wireless devices;
one or more processors; and
a memory comprising instructions that, when executed by the one or more processors, cause the apparatus to:
negotiate a passive ranging schedule between an initiator device and a number of responder devices, the passive ranging schedule indicating a time prior to a selected target beacon transmission time (TBTT) at which the ranging operation is to commence;
announce the passive ranging schedule to the number of responder devices and to a number of passive listening devices;
commence the ranging operation at the indicated time by exchanging a number of frames between the initiator device and the number of responder devices;
facilitate a passive positioning operation for each of the passive listening devices using the exchanged frames; and
complete the exchange of frames prior to the selected TBTT.

14. The apparatus of claim 13, wherein the passive ranging schedule comprises a participant field including at least one of an identity of each device participating in the ranging operation, an indication of whether each of the identified participant devices is an access point or a client device, and an indication of whether each of the identified participant devices is to operate as the initiator device or as one of the responder devices.

15. The apparatus of claim 13, wherein the passive ranging schedule comprises a parameters field including at least one of a type of frames to be exchanged during the ranging operation, a number of antennas to be used by the responder devices during the ranging operation, a frequency bandwidth to be used for transmitting the frames, a wireless channel to be used for the ranging operation, a capability to capture timestamps of the frames, and a capability to estimate angle information of the frames.

16. The apparatus of claim 13, wherein the passive ranging schedule comprises a synchronization field including mappings between a clock domain of the initiator device and clock domains of each of the responder devices, wherein the mappings comprise at least clock offset values between the clock domain of the initiator device and the clock domains of the responder devices.

17. The apparatus of claim 13, wherein execution of the instructions for announcing the passive ranging schedule causes the apparatus to:
broadcast the passive ranging schedule in every N^{th} beacon frame, wherein each beacon frame includes a counter value indicating which of the beacon frames includes the passive ranging schedule, and wherein N is an integer greater than one.

18. The apparatus of claim 13, wherein the frames are exchanged according to a fine timing measurement (FTM) protocol and comprise a number of multi-user null data packets (MU-NDPs), and at least one of the MU-NDPs comprises an uplink (UL) MU-NDP transmitted from multiple antennas of a respective one of the responder devices.

19. The apparatus of claim 13, wherein execution of the instructions for exchanging the number of frames causes the apparatus to:
transmit, to the responder devices, a downlink null data packet (DL NDP) including a plurality of sounding sequences from which a corresponding plurality of round trip time (RTT) values are obtained;
transmit a trigger frame to the responder devices;
receive an uplink multi-user null data packet (UL MU-NDP) from each of the responder devices identified by the trigger frame; and
transmit, to the responder devices, a beacon frame including timing information indicating time of arrival (TOA) values of the UL MU-NDPs received at the initiator device and indicating a time of departure (TOD) value of the DL NDP transmitted from the initiator device.

20. The apparatus of claim 13, wherein execution of the instructions for exchanging the number of frames causes the apparatus to:
transmit a trigger frame to the responder devices;
receive an uplink multi-user null data packet (UL MU-NDP) from each of the responder devices identified by the trigger frame;
transmit a downlink null data packet (DL NDP) to the responder devices; and
transmit, to the responder devices, a downlink feedback (DL FB) frame including timing information indicating time of arrival (TOA) values of the UL MU-NDPs at the initiator device and indicating a time of departure (TOD) value of the DL NDP transmitted from the initiator device.

21. The apparatus of claim 20, wherein the DL FB frame further includes at least one of angle of departure (AoD) information of the UL MU-NDPs transmitted from the responder devices, location information of the initiator device, and location information of one or more of the responder devices.

22. The apparatus of claim 20, wherein the DL NDP further comprises a null data packet announcement (NDPA).

23. The apparatus of claim 20, wherein execution of the instructions for exchanging the number of frames further causes the apparatus to:
receive, from each of the responder devices, an uplink multi-user (UL MU) frame including timing information indicating TOD values of the UL MU-NDPs transmitted from the responder devices and indicating TOA values of the DL NDP arriving at the responder devices.

24. The apparatus of claim 23, wherein execution of the instructions for facilitating the passive ranging operation causes the apparatus to:
enable the passive listening device to determine a differential distance between itself and each of a pair of the initiator device and one of the responder devices based on the timing information included in the DL FB frame, the timing information included in the UL MU frames transmitted from the pair of the responder devices, and TOA values of the UL MU-NDPs at the passive listening device.

25. A non-transitory computer-readable storage medium comprising instructions that, when executed by one or more processors of an apparatus, cause the apparatus to perform operations comprising:
negotiating a passive ranging schedule between an initiator device and a number of responder devices, the passive ranging schedule indicating a time prior to a selected target beacon transmission time (TBTT) at which the ranging operation is to commence;
announcing the passive ranging schedule to the number of responder devices and to a number of passive listening devices;
commencing the ranging operation at the indicated time by exchanging a number of frames between the initiator device and the number of responder devices;
facilitating passive positioning operations for one or more of the passive listening devices using the exchanged frames; and
completing the exchange of frames prior to the selected TBTT.

26. The non-transitory computer-readable storage medium of claim 25, wherein execution of the instructions for exchanging the number of frames causes the apparatus to perform operations further comprising:
transmitting, to the responder devices, a downlink null data packet (DL NDP) including a plurality of sounding sequences from which a corresponding plurality of round trip time (RTT) values are obtained;
transmitting a trigger frame to the responder devices;
receiving an uplink multi-user null data packet (UL MU-NDP) from each of the responder devices identified by the trigger frame; and
transmitting, to the responder devices, a beacon frame including timing information indicating time of arrival (TOA) values of the UL MU-NDPs received at the initiator device and indicating a time of departure (TOD) value of the DL NDP transmitted from the initiator device.

27. The non-transitory computer-readable storage medium of claim 25, wherein execution of the instructions for exchanging the number of frames causes the apparatus to perform operations further comprising:
transmitting a trigger frame to the responder devices;
receiving an uplink multi-user null data packet (UL MU-NDP) from each of the responder devices identified by the trigger frame;
transmitting a downlink null data packet (DL NDP) to the responder devices; and
transmitting, to the responder devices, a downlink feedback (DL FB) frame including timing information indicating time of arrival (TOA) values of the UL MU-NDPs at the initiator device and indicating a time of departure (TOD) value of the DL NDP transmitted from the initiator device.

28. The non-transitory computer-readable storage medium of claim 27, wherein execution of the instructions for exchanging the number of frames causes the apparatus to perform operations further comprising:
receiving, from each of the responder devices, an uplink multi-user (UL MU) frame including timing information indicating TOD values of the UL MU-NDPs transmitted from the responder devices and indicating TOA values of the DL NDP arriving at the responder devices.

29. The non-transitory computer-readable storage medium of claim 28, wherein execution of the instructions for facilitating the passive ranging operation causes the apparatus to perform operations further comprising:
enabling the passive listening device to determine a differential distance between itself and each of a pair of the initiator device and one of the responder devices based on the timing information included in the DL FB frame, the timing information included in the UL MU frames transmitted from the pair of the responder devices, and TOA values of the UL MU-NDPs at the passive listening device.

30. An apparatus for performing a ranging operation, comprising:
means for negotiating a passive ranging schedule between an initiator device and a number of responder devices, the passive ranging schedule indicating a time prior to a selected target beacon transmission time (TBTT) at which the ranging operation is to commence;
means for announcing the passive ranging schedule to the number of responder devices and to a number of passive listening devices;
means for commencing the ranging operation at the indicated time by exchanging a number of frames between the initiator device and the number of responder devices;
means for facilitating a passive positioning operation for each of the passive listening devices using the exchanged frames; and
means for completing the exchange of frames prior to the selected TBTT.
